(19) United States
(12) Patent Application Publication
(10) Pub. No.: US 2003/0185334 A1
(43) Pub. Date: Oct. 2, 2003

(54) Core inlet structure for coolant

(75) Inventors: Toshihiro Fujii, Yokohama-Shi (JP); Shiho Fujita, Yokohama-Shi (JP); Akira Mototani, Yokohama-Shi (JP); Hideo Komita, Yokohama-Shi (JP); Miyuki Akiba, Tokyo (JP); Tadashi Narabayashi, Yokohama-Shi (JP); Masaru Ukai, Yokohama-Shi (JP); Shinichi Morooka, Tokyo (JP); Tetsuzo Yamamoto, Yokosuka-Shi (JP); Ryoma Kato, Yokohama-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/403,283

(22) Filed: Apr. 1, 2003

(30) Foreign Application Priority Data
Apr. 1, 2002 (JP) 2002-098984
Oct. 11, 2002 (JP) 2002-299645

(51) Int. Cl. G21C 3/34

(52) U.S. Cl. 376/439

(57) ABSTRACT

A core inlet structure for coolant disposed in a reactor pressure vessel of a boiling water reactor includes a core support plate provided with a plurality of fuel support holes, a reinforcing beam supporting the core support plate, a plurality of control rod guide pipes standing perpendicularly and having upper end portions fitted to the fuel support holes, and a fuel support member inserted into upper end portions of the control rod guide pipes and supported by the core support plate so as to support lower end portions of fuel assemblies. An inlet orifice is formed to the fuel support member so as to adjust flow rate of a coolant flowing in the fuel assemblies, and a vortex control structure is provided for the inlet orifice or provided at a portion on a coolant upstream side of the inlet orifice.

### BACKGROUND OF THE INVENTION

Field of the Invention

The present invention relates to a coolant inlet structure of a reactor core for introducing the coolant (called herein merely core inlet structure for coolant or core coolant inlet structure) capable of making even or uniform flow rate of the coolant passing through fuel assembly charged in a core of a boiling water reactor (BWR), and more particularly, to a core inlet structure for coolant adapted to make even the coolant flow rate by reducing flow passage pressure loss factor at the coolant inlet portion of a fuel support member (fitting) of the reactor core.

In ABWR, an upper lattice plate, a core shroud, and a core support plate are arranged in a reactor pressure vessel. Inside the core shroud, several hundreds of fuel assemblies are vertically arranged in shape of lattice, thus constituting a reactor core.

At a reactor running (operation) period, coolant is recycled to the core by operating the recirculation pump disposed at the lower portion of the reactor pressure vessel 1. More in detail, the coolant rises upward from the core lower portion into the fuel assemblies (which may be merely called fuel assembly herein) and heated therein to thereby produce two phase-flow including steam and water component, which are separated by a steam separator 3. The steam further rises and is introduced into a main steam pipe with the water component being separated by a steam dryer and then guided to a turbine, not shown. On the other hand, the water in single-phase separated through the steam separator and the steam dryer descends and is then guided to the recirculation pump through an outside of the reactor shroud. Thereafter, the water component again rises towards the core and then passes through the fuel assembly.

In order to properly distribute the flow rate of the coolant flowing into the respective fuel assemblies, the inlet orifices are adjusted.

The flow rates of the coolant passing through the respective fuel assemblies are determined on the basis of the passage pressure loss factor which is determined by the diameters of the inlet orifices near the core support plate and the reinforcing beam, the structure of the fuel assemblies and so on. Further, the passage pressure loss factor mentioned herein is a value K defined by the following equation 1.

K=ΔP/Q² [Equation 1]

(ΔP is a pressure difference in a certain period and Q² is a flow rate.) Further, the symbol Q may represent volume flow rate or mass flow rate.

According to the magnitude of the power generated by the fuel assemblies, bubbles produced inside the fuel assemblies will be different, and for this reason, the passage pressure loss factors in the fuel assemblies become different. However, in a design of a general BWR power plant, the diameters or like of the inlet orifices are adjusted so that the flow rate can be made even (uniformly distributed) provided that the respective fuel assemblies have same output power.

In the design of a conventional general BWR power plant, the diameters of the inlet orifices are adjusted so that the rate of flow flowing into the fuel assemblies can be made even, and the inlet orifices of the same diameter are used in the same condition of the coolant passage. However, in the design that the inlet orifices having the same shape are arranged to the portion of the coolant passage in which the condition of the coolant passage is same, it has been observed that the flow rate of the coolant flowing the respective fuel assemblies is not same.

### SUMMARY OF THE INVNETION

The present invention was conceived in consideration of the above circumstances to substantially eliminate defects or drawbacks encountered in the prior art mentioned above and an object of the present invention is to provide a core inlet structure for coolant of a reactor power plant capable of making proper the passage pressure loss factor in the core inlet structure for coolant by solving a problem of uneven coolant flow rate at an inlet orifice portion of a fuel assembly and properly adjusting the coolant flow rate in the fuel assembly.

That is, the present invention provides a core inlet structure for coolant disposed in a reactor pressure vessel of a boiling water reactor, comprising:

a core support plate provided with a plurality of fuel support holes;

a reinforcing beam supporting the core support plate from a lower portion thereof in an installed state of the reactor;

a plurality of control rod guide pipes standing perpendicularly upward from a bottom side of the reactor pressure vessel and having upper end portions fitted respectively to the fuel support holes formed to the core support plate;

a fuel support member inserted into upper end portions of the control rod guide pipes and supported by the core support plate vertically in the core so as to support lower end portions of fuel assemblies arranged in the core;

an inlet orifice formed to the fuel support member so as to adjust flow rate of a coolant flowing in the fuel assemblies; and

vortex control means for controlling vortex of the coolant flowing into the inlet orifice formed to the fuel support member, the vortex control means being provided in the core inlet structure at a portion except downstream from the inlet orifice.

According to the present invention of the structures and characters mentioned above, the pressure loss factor or efficiency at the portion of the inert orifice of the reactor core can be made proper and, hence, the flow rate in the fuel assembly can be suitably adjusted.

The further nature and characteristic features will be made more clear from the following descriptions made with reference to the accompanying drawings.

### BRIEF DESCRIPTION OF THE DRAWINGS

In the accompanying drawings:

FIG. 1 is a vertical cross-sectional view of a core inlet structure for coolant, according to a first embodiment of the present invention, illustrating flow of the coolant directed toward an inlet orifice thereof in a passage section;

FIG. 2 is a perspective view of a fuel support member used in the first embodiment of the present invention;

FIG. 3A is a descriptive view of operation of the embodiment of the present invention, and FIG. 3B is a view illustrating characteristic properties provided by the first embodiment of the present invention;

FIG. 4 is a vertical cross-sectional view of the core inlet structure for coolant, according to a second embodiment of the present invention, illustrating flow of the coolant directed toward the inlet orifice thereof in the passage section;

FIG. 5 is a vertical cross-sectional view of the core inlet structure for coolant, according to a third embodiment of the present invention, illustrating flow of the coolant directed toward the inlet orifice thereof in the passage section;

FIG. 6A is an enlarged cross-sectional view of a portion “E” in FIG. 5 and FIG. 6B is an enlarged cross-sectional view of the portion “E” as modified;

FIG. 7 is a vertical cross-sectional view of the core inlet structure for coolant, according to a fourth embodiment of the present invention, illustrating flow of the coolant directed toward the inlet orifice thereof in the passage section;

FIG. 8 is a vertical cross-sectional view of the core inlet structure for coolant, according to a fifth embodiment of the present invention, illustrating flow of the coolant directed toward the inlet orifice thereof in the passage section

FIG. 9 is a horizontal cross-sectional view of the core inlet structure for coolant, according to a sixth embodiment of the present invention, illustrating flow of the coolant directed toward the inlet orifice thereof in the passage section;

FIG. 10 is a horizontal cross-sectional view of the core inlet structure for coolant, according to a seventh embodiment of the present invention, illustrating flow of the coolant directed toward the inlet orifice thereof in the passage section;

FIG. 11 is a vertical cross-sectional view of the core inlet structure for coolant, according to an eighth embodiment of the present invention, illustrating flow of the coolant directed toward the inlet orifice thereof in the passage section;

FIG. 12 is an enlarged side view illustrating the inlet orifice as shown in FIG. 11;

FIG. 13 is a descriptive view of the structure of a ninth embodiment of the present invention;

FIG. 14 is a descriptive view of the structure of a tenth embodiment of the present invention;

FIG. 15 is a vertical cross-sectional view of the core inlet structure for coolant, according to an eleventh embodiment of the present invention, illustrating flow of the coolant directed toward the inlet orifice thereof in the passage section;

FIG. 16 is a side view illustrating the inlet orifice as shown in FIG. 15;

FIG. 17 is a vertical cross-sectional view of the core inlet structure for coolant, according to a twelfth embodiment of the present invention, illustrating flow of the coolant directed toward the inlet orifice thereof in the passage section;

FIG. 18 is an enlarged cross-sectional view cut along the line XVIII-XVIII in FIG. 17;

FIG. 19 is a side view illustrating the inlet orifice as shown in FIG. 17;

FIG. 20 is a vertical cross-sectional view of the core inlet structure for coolant, according to a thirteenth embodiment of the present invention, illustrating flow of the coolant directed toward the inlet orifice thereof in the passage section;

FIG. 21 is a side view illustrating the inlet orifice as shown in FIG. 20;

FIG. 22 is a vertical cross-sectional view of the core inlet structure for coolant, according to the thirteenth embodiment of the present invention, illustrating a modification of the passage section;

FIG. 23 is a side view illustrating the inlet orifice as shown in FIG. 22;

FIG. 24 is a vertical cross-sectional view of the core inlet structure for coolant, according to a fourteenth embodiment of the present invention, illustrating flow of the coolant directed toward the inlet orifice thereof in the passage section;

FIG. 25 is a side view illustrating the inlet orifice as shown in FIG. 24;

FIG. 26 is a vertical cross-sectional view of the core inlet structure for coolant, according to a fifteenth embodiment of the present invention, illustrating flow of the coolant directed toward the inlet orifice thereof in the passage section;

FIG. 27 is a side view illustrating the inlet orifice as shown in FIG. 26;

FIG. 28 is a vertical cross-sectional view of the core inlet structure for coolant, according to a sixteenth embodiment of the present invention, illustrating flow of the coolant directed toward the inlet orifice thereof in the passage section;

FIG. 29 is a side view illustrating the inlet orifice as shown in FIG. 28;

FIG. 30 is a vertical cross-sectional view of the core inlet structure for coolant, according to a seventeenth embodiment of the present invention, illustrating flow of the coolant directed toward the inlet orifice thereof in the passage section;

FIG. 31 is a side view illustrating the inlet orifice as shown in FIG. 30;

FIG. 32 is schematic cross-sectional view illustrating the entire structure of a reactor pressure vessel;

FIG. 33 is an enlarged cross sectional view illustrating a fuel assembly as shown in FIG. 32;

FIG. 34A is a perspective view illustrating an example of combination of a core support plate and a reinforcing beam and FIG. 34B is a perspective view illustrating another example of the reinforcing beam;

FIG. 35 is a plan view illustrating an arrangement of the fuel support member;

FIG. 36 is an enlarged plan view of a portion as shown in FIG. 35;

FIG. 37 is a vertical cross-sectional view illustrating occurrence of swirls; and

FIG. 38 is a view illustrating occurrence of the swirls, viewed in the direction as shown in the form of line XXXVIII-XXXVIII in FIG. 37.

### DESCRIPTION OF THE PREFERRED EMBODIMENTS

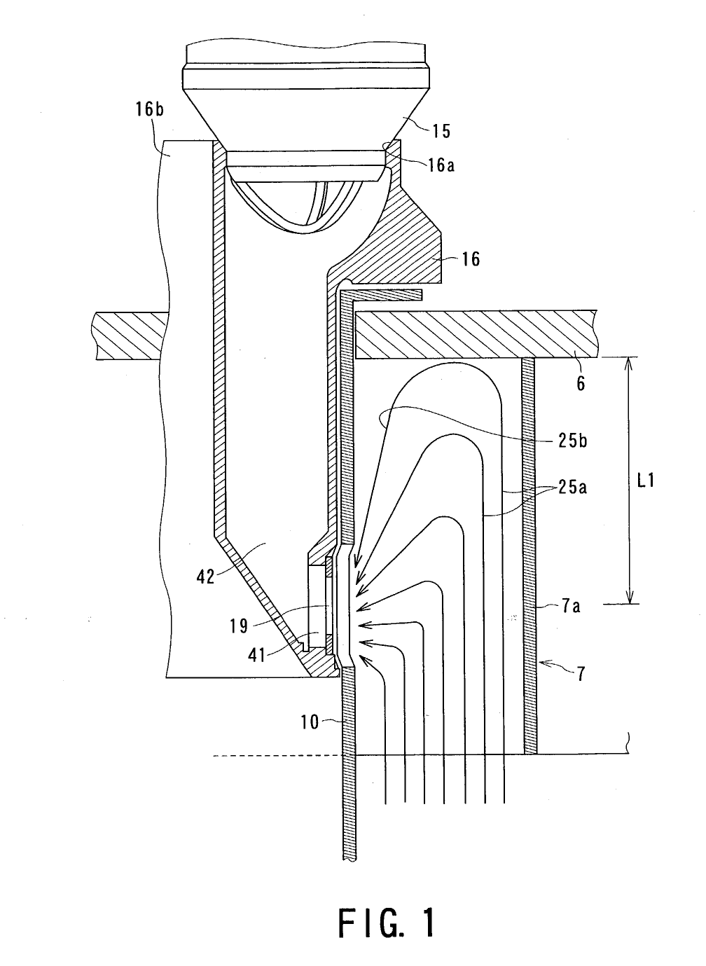

Now, embodiments of the present invention will be described in detail below with reference to FIGS. 1 to 38.

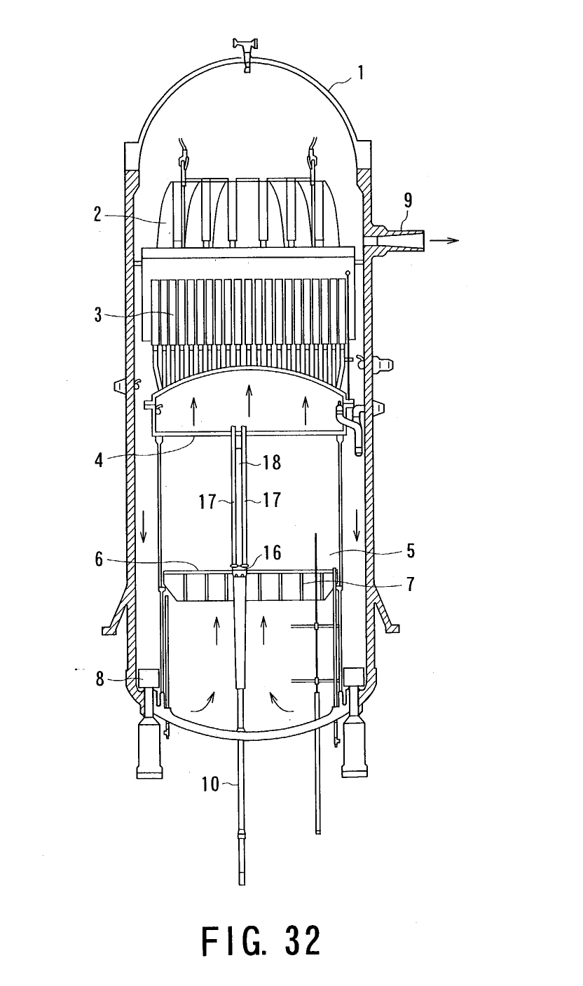

A reactor pressure vessel of an advanced type boiling water reactor (ABWR) having a general structure is shown in FIG. 32. There are arranged, in the described order from the upper side in a reactor pressure vessel 1, a steam dryer 2, a steam separator 3, an upper lattice plate 4, a core shroud 5, a core support plate 6. Inside the core shroud 5, several hundreds of fuel assemblies 17 are vertically arranged in shape of lattice, thus constituting a reactor core. In the reactor, control rods 18 are introduced into a reactor core inlet portion from the lower portion thereof through a control rod guide pipe or tube 10. A plurality of recirculation pumps 8 for coolant circulation are disposed to the lower portion of the reactor pressure vessel 1. The reactor pressure vessel 1 is provided at the upper portion thereof with a main steam pipe 9.

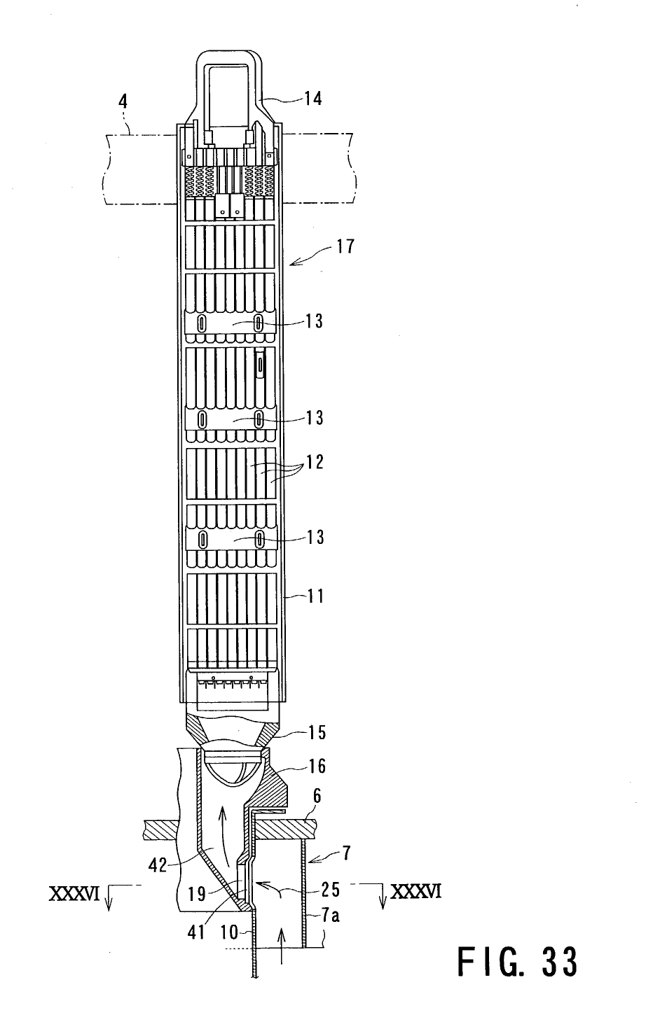

FIG. 33 is a sectional view showing the fuel assembly 17 and a support structure therefore in an enlarged scale. The fuel assembly 17 comprises a channel box 11 having an elongated rectangular cylindrical shape and having upper and lower ends opened, a number of fuel rods 12 arranged in parallel and containing fissionable material, a plurality of fuel spacers 13 supporting the fuel rods 12 at vertical several positions in the channel box 11 and upper and lower tie plates 14 and 15 securing upper and lower end portions of the fuel rods 12 so that the coolant can pass therethrough. The upper and lower end portions of these fuel assemblies 17 are supported by an upper lattice plate 4 and a core support plate 6.

The lower end portion of the fuel assembly 17 over an inner portion of the core support plate 6, is supported by fuel support member (fitting) 16. The fuel support member 16 shown in FIG. 33 has a structure for supporting four fuel assemblies 17 in lattice arrangement in which the control rod 18 is inserted into the central portion thereof. The fuel support member 16 is disposed in the upper end portion of the control rod guide pipe 10. A coolant introducing inlet port 41 for introducing the coolant is formed to the support member 16 in a horizontal direction to an outer surface of the peripheral wall of the control rod guide pipe 10. An inlet orifice 19 is formed to this coolant inlet port 41. A coolant passage 42 is formed in the central fuel support member 16. A coolant passage 42 guides the coolant flowed in through the coolant inlet port 41 to each of the fuel assemblies 17.

On the other hand, over a peripheral portion of the core support plate 6, one fuel assembly 17 is supported by a peripheral fuel support member, which is not shown. The peripheral fuel support member has a perpendicular tubular structure having a downward opening through which the coolant rises directly upward. The coolant can smoothly flows, and hence, a flow passage pressure loss factor or coefficient is less significant according to such structure.

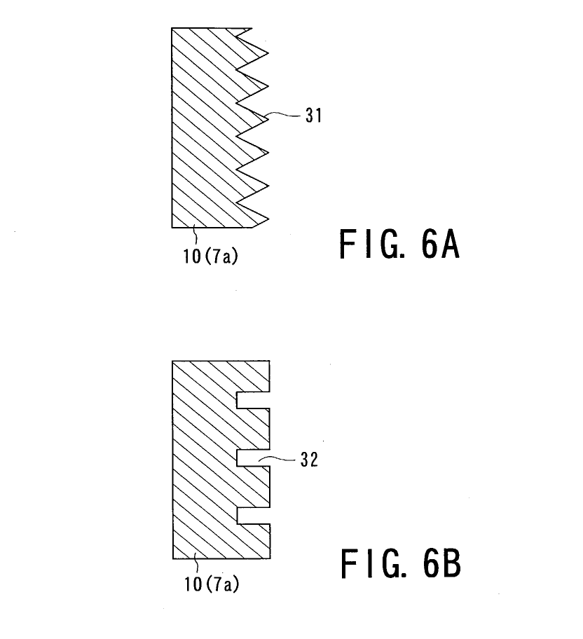

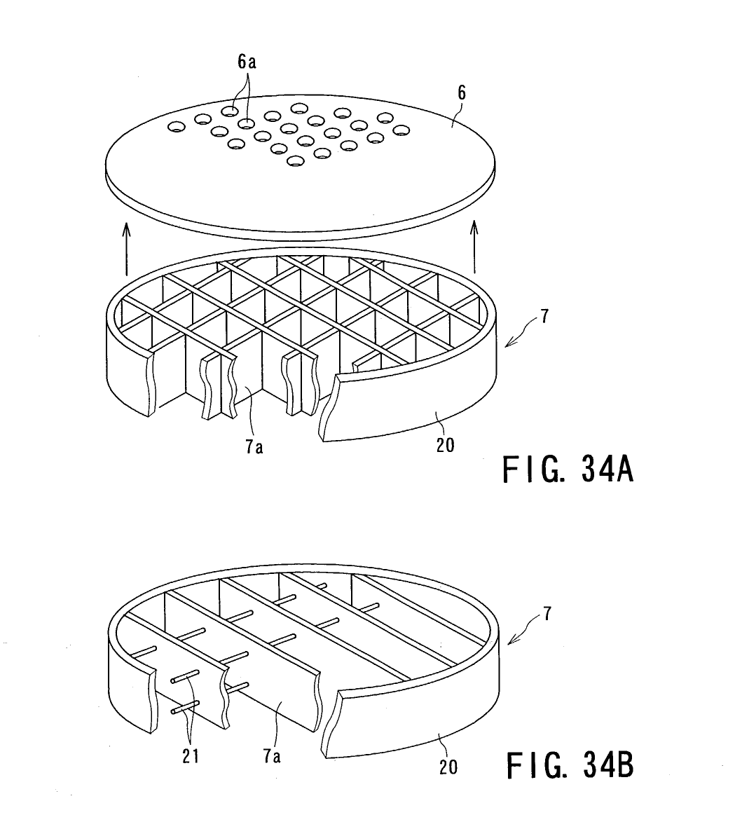

With reference to FIG. 34 showing an entire structure of the core support plate 6 and the reinforcing beam 7, in which FIG. 6A shows a cross-beam as one example of the core support plate 6 and the reinforcing beam 7. The core support plate 6 has a horizontal disc shape and provided with a plurality of holes 6a for mounting the fuel support member 16.

FIG. 34A shows the core support plate 6 and the reinforcing beam 7. The core support plate 6 has a horizontal disc shape and provided with a plurality of holes 6a for mounting the fuel support member 16. The reinforcing beam 7 as cross-beam member has a circular frame 20 in which the vertical beam plates 7a are arranged in square lattice structure, and the upper edges of the respective beam plates 7a of the cross-beam member are jointed to the lower surface of the core support plate 6, thus providing a reinforcing structure.

FIG. 34B represents another structure of the reinforcing beam 7 as single-beam member. The single-beam member has a circular frame 20 in which a plurality of vertical beam plates 7a are arranged in parallel to each other and connection rods 21 perpendicular to these vertical beam plates 7a are also arranged so as to provide the square lattice arrangement. The present invention includes the case where a single beam as shown in FIG. 34B is used as the reinforcing beam. Although, the cross-beam member which is used in the embodiments is excellent in mechanical strength.

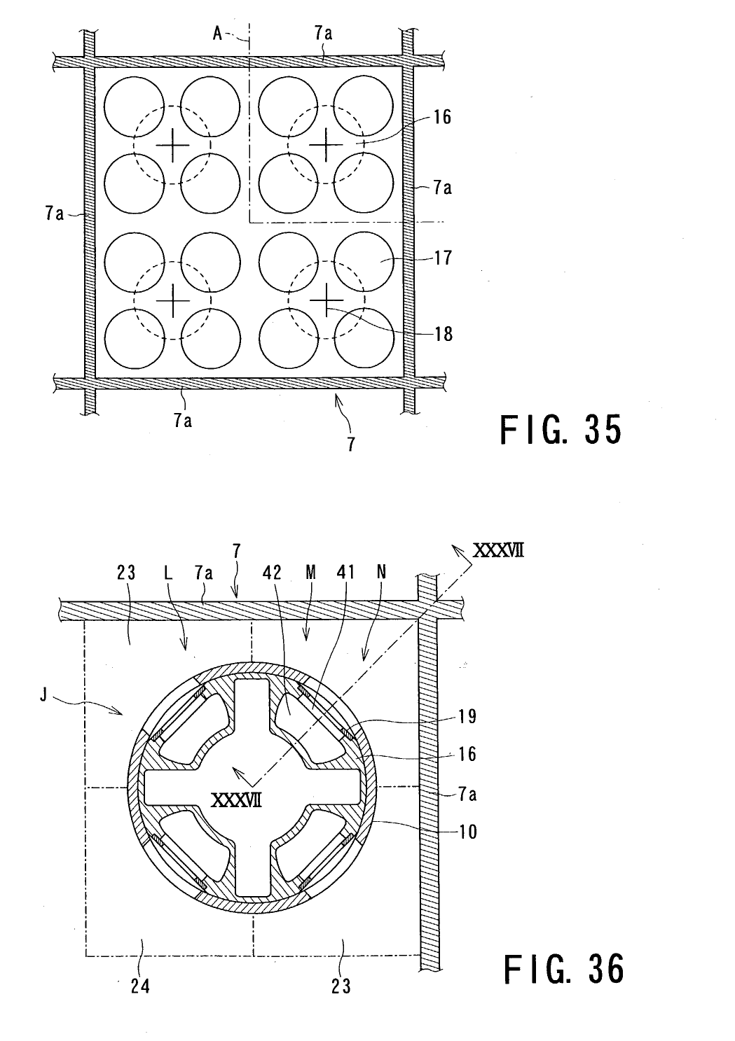

FIG. 35 is a view, in an enlarged scale, showing, in a plane view, the relationship in arrangement among the fuel support members 16, the fuel assemblies 17 and the control rods 18 disposed in one lattice space formed by the beam plates 7a of the reinforcing beam 7. FIG. 36 shows a quarter (right upper 1/4 portion) of the structure of FIG. 35 (sectional view taken along the line XXXVI-XXXVI in FIG. 33

With reference to FIG. 36, in one area square in a plan view surrounded by the reinforcing beam plates 7a, four control rod guide pipes 10 and the four fuel support members 16 are arranged so as to form a lattice shape. Four fuel assemblies 17 are supported by a fuel support member 16. Thus, totally sixteen fuel assemblies 17 are arranged in one area surrounded by the reinforcing beam plates 7a.

It is further noted that terms of “right”, “left”, “upper”, “lower”, and the like terms are used herein with reference to the illustrated state in the following preferred embodiments or actual reactor core installed state.

First Embodiment (FIGS. 1 to 3B)

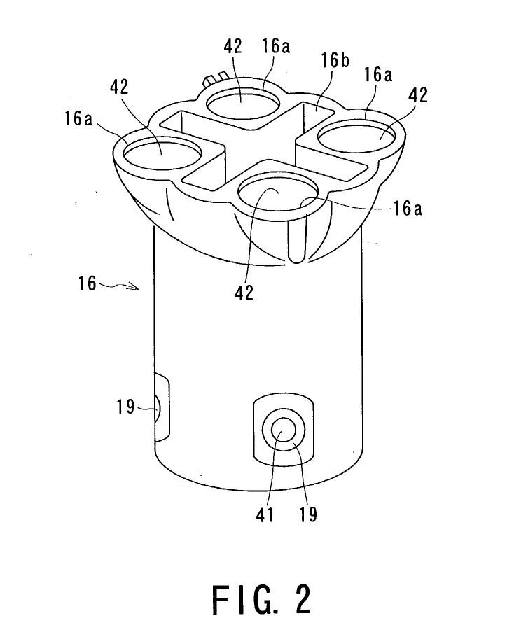

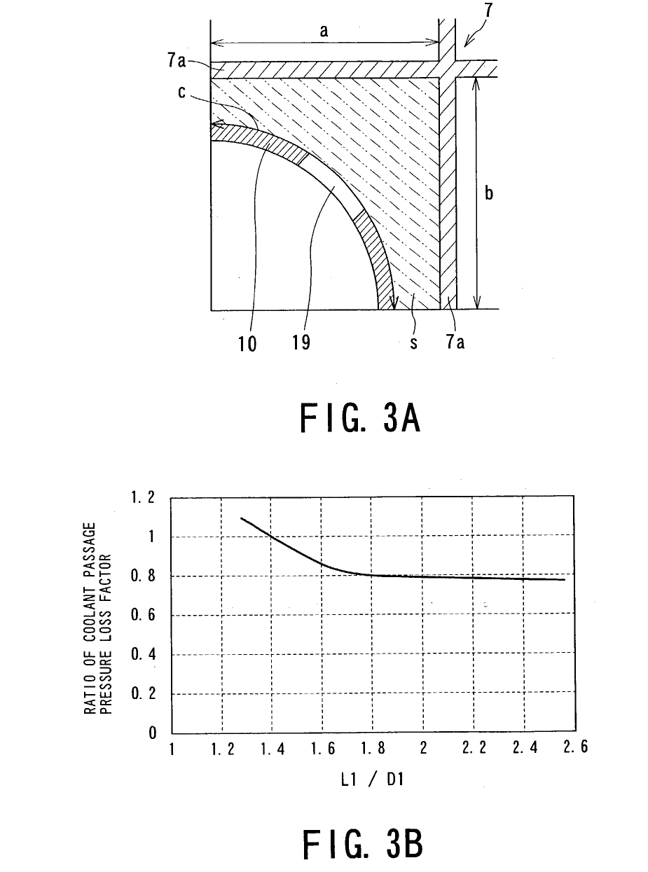

FIG. 1 is a vertical cross-sectional view of a core inlet structure for coolant, according to the first embodiment of the present invention, illustrating flow of the coolant directed toward an inlet orifice thereof in a passage section. FIG. 2 is a perspective view of a fuel support member (fitting) used in the first embodiment of the present invention. FIGS. 3A and 3B are descriptive views of operation.

As shown in FIGS. 1 and 2, the core inlet structure for coolant, according to the first embodiment of the present invention includes: a core support plate 6 having a plurality of fuel support holes, which is placed in a reactor pressure vessel of a boiling water reactor; a reinforcing beam 7 for reinforcing the core support plate 6 from the lower side thereof; a plurality of control rod guide pipes 10, which stand vertically from the bottom side of the reactor pressure vessel and have their respective upper ends that are fitted into the fuel support holes of the core support plate 6, respectively; fuel support members (fittings) 16 each inserted into each upper end of the control rod guide pipes so as to support each lower end of a plurality of fuel assemblies 15, which are supported by the core support plate 6 so as to be placed vertically in a core; and an inlet orifice 19 provided in each of the fuel support members 16 to control flow rate of coolant flowing into the fuel assembly 15. Further, it is to be noted that the term “orifice” designated by reference numeral 19 is herein equivalently used as “orifice plate” as shown in the drawings.

The fuel support member 16 has four fuel supporting sections 16a for supporting the same number of fuel assemblies 15 and a control rod insertion hole 16b placed in a central position of the fuel support member 16. The fuel support member 16 having the above-described structure is provided on the upstream side of the inlet orifice 19, which is formed in the fuel support member 16, with a vortex control device for controlling a vortex or swirl of the coolant flowing into the inlet orifice 19. The vortex control device weakens a descending current of the coolant, which comes from the side of the core support plate 6 to the inlet orifice 19, so as to weaken a circling current, which is to move into the inlet orifice 19, making a vortex around a horizontal axis, thus preventing occurrence of the vortex or swirl.

In the core inlet structure for coolant, according to the first embodiment, the vortex control device has a structure that satisfies the following requirement of:

(1) L1/D1≧0.7

wherein, L1 is a distance from the lower surface of the core support plate 6 to the central position of the inlet orifice 19 of the fuel support member 16, and D1 is a value as a typical diameter of the inlet passage, which is obtained by dividing the cross-sectional area “S” as shown in FIG. 3A of the ascending current passage by the sum “(a+b+c)” of a length “c” of a quarter-arc of the outer peripheral surface of the control rod guide pipe 10, which conceivably forms the ascending current passage for the coolant, associated with the single inlet orifice 19, on the one hand, and the horizontal lengths “a and b” of a beam plate 7a of the reinforcing beam 7, with which the above-mentioned quarter-arc is surrounded, on the other hand; and

(2) requirement of the center of the inlet orifice 19 being placed above the lower end of the reinforcing beam 7.

FIG. 3B is a graph in which experimental results concerning relationship between the value of “L1/D1” and a ratio of passage pressure loss factor of the inlet orifice 19 are plotted. The abscissa of the graph indicates the value of “L1/D1” and the ordinate thereof, the ratio of passage pressure loss factor of the inlet orifice 19. The experiment was carried out under conditions including a pressure of the coolant of about 7 MPa, a temperature thereof of about 280° C. and a flow rate thereof of about 2 m/second.

The ratio of passage pressure loss factor gradually decreases with an increase in the value of “L1/D1” as shown in FIG. 3B. When the value of “L1/D1” is greater than about 1.7, the ratio of passage pressure loss factor decreases in little. In the conventional coolant inlet structure of a reactor core, the value of “L1/D1” is about 1.4, at which the ratio of passage pressure loss factor really decreases with an increase in the value of “L1/D1”.

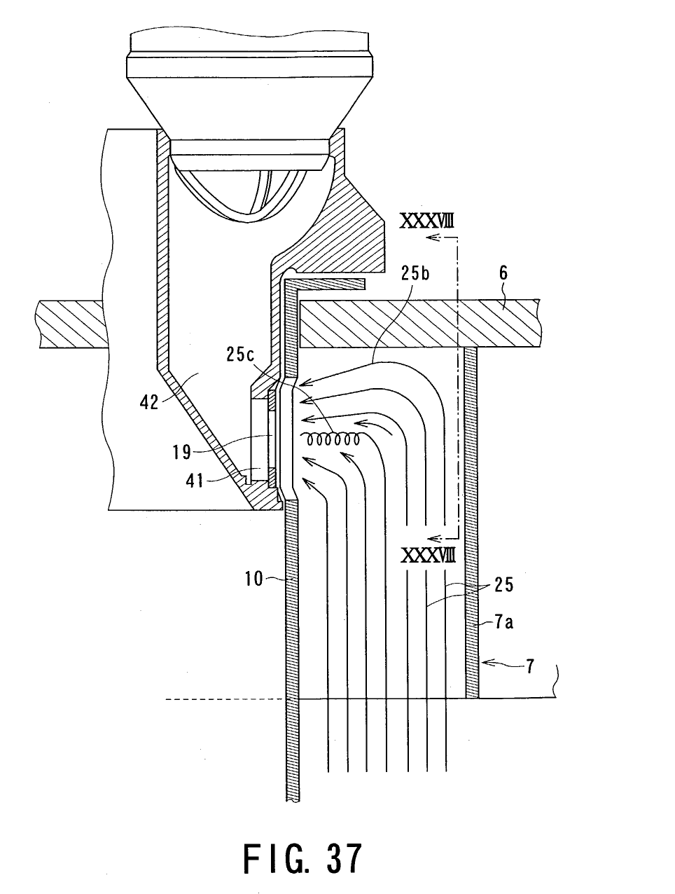

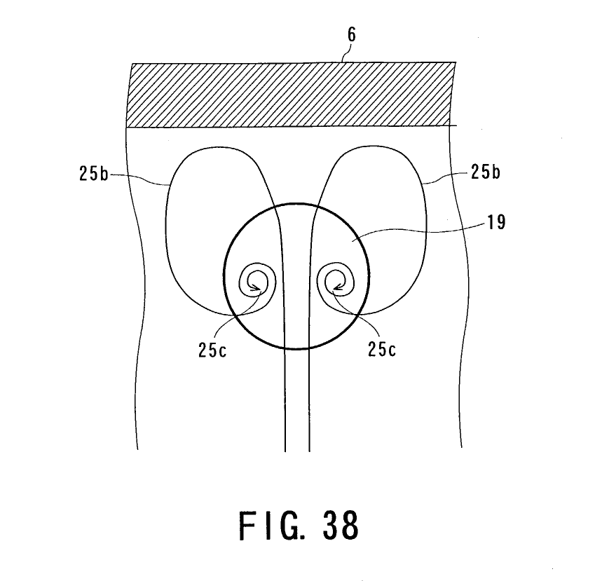

This phenomenon is caused by the vortex or swirl of the coolant flowing into the inlet orifice 19. Such phenomenon will be explained with reference to FIGS. 36, 37 and 38, in which FIG. 37 is a sectional view taken along the line XXXVII-XXXVII in FIG. 36 schematically showing a state of flow of the coolant at the inlet orifice 19 opened in opposition in the diagonal direction of the beam plates 7a of the reinforcing beam 7 arranged in a square lattice form, and FIG. 38 shows flow of the coolant at the section XXXVIII-XXXVIII in FIG. 37 in the front view of the inlet orifice 19.

In these FIGS. 37 and 38, reference numeral 25 denotes flow lines (rising or ascending current flow) of the coolant. As shown by such flow lines 25, the coolant rising from the lower portion of the reactor pressure vessel 1 flows, as ascending flow, in the gap between the beam plates 7a of the reinforcing beam 7 and the control rod guide pipe 10. When a part of the coolant reaches the position of the inlet orifice 19, the coolant changes in its flow direction to the horizontal direction so as to directly flow in the inlet orifice 19.

In this case, the passage pressure loss factor in the area J becomes smaller than that in the area L near the beam plates 7a. Hence, the flow speed (velocity) of the coolant rising in the area J becomes faster than that in the area L. Accordingly, the coolant rising through the area J collides with the lower surface of the core support plate 6 and then flows downward through the area L at a slow-downed speed. The opposite direction coolant flows in the area J and L cause a vortex in the coolant flowing into the inlet orifice 19. A distance between a horizontally central beam plate 7a of an inlet orifice N shown in FIG. 36 and the control rod guide pipe 10 is wider than a distance between a horizontally peripheral beam plate 7a of an inlet orifice M shown in FIG. 36 and the control rod guide pipe 10. The passage pressure loss factor at the position M becomes smaller than that at the position N, and a vortex is generated In the area N and M facing the corner portion of the two beam plates 7a like the position L.

In a area facing the corner portion of the two beam plates 7a crossing at right angle to each other, the positional relationship between the beam plates 7a and the control rod guide pipe 10 is symmetric with respect to the horizontal direction. As shown in FIG. 38, two downward currents 25b flow down in the horizontal peripheral area of the inlet orifice 19, and two vortexes 25c, so-called twin-vortex, are caused. The formation of such vortex was clearly observed in a test carried out by utilizing an actual shape, under conditions of pressure of about 7 Mpa, temperature of about 280° C., and flow velocity of about 2 km/s.

In the case where the coolant flows into the inlet orifice 19 with such vortex 25c, the passage pressure loss factor at the inlet orifice 19 increases. The passage pressure loss factor at the inlet orifice 19 is increased in much by the strong vortex flowing into the inlet orifice 19. In the case of the symmetric twin vortex like in the corner portion of the two beam plates 7a crossing at right angle to each other, the conditions or states of these vortexes differ in accordance with mere difference of shape within a tolerance of manufacture, and the passage pressure loss factor at the inlet orifice 19 is changed. Further, in the case of the symmetric twin vortex, the conditions or states of these vortexes of the vortex largely change in elapsing of time. The large changing of passage pressure loss factor at the inlet orifice 19 caused by the condition changing of the symmetric twin vortex makes it difficult to adjust the inlet orifice 19 for the proper flow rate of the coolant flowing the respective fuel assemblies 17. When The value of “L1/D1” is greater than 1.7, the little increase of passage pressure loss factor at the inlet orifice 19 caused by the vortex makes little the changing of the passage pressure loss factor at the inlet orifice 19. Then, the value of “L1/D1” is set as 1.7 or more in the first embodiment of the present invention.

When the value of “L1/D1” is about 1.7 and the value of “D1” is 4, the distance “L1” from the lower surface of the core support plate 6 to the central position of the inlet orifice 19 of the fuel support member 16 is about 7 cm, and downward current 25b form the lower surface of the core support plate 6 to the inlet orifice 19 is longer than that in the conventional prior art. The movement of the downward current 25b by the long distance attenuates the downward current 25b itself, and makes the vortex of the coolant flowing into the inlet orifice 19.

Placing the inlet orifice 19 below the core support plate 6 as lower as possible relative thereto can provide more effective results. An excessively lower position of the inlet orifice 19 however leads to increase in height of the fuel support member 16 as well as required costs for manufacture of the fuel support member 16 and deterioration of productivity thereof. It is preferable to set the position of the inlet orifice 19 so as not to be placed below the lower surface of the reinforcing beam 7.

The increase and change of passage pressure loss factor due to the occurrence of the swirl in the vicinity of the inlet orifice 19 is made little by modifying the structure of the fuel support member 16 and the control rod guide pipe 10 so as to place the inlet orifice 19 in a lower position than that as normally designed. It is possible to adjust the flow rate of the coolant flowing into the fuel assembly 17 in an appropriate manner.

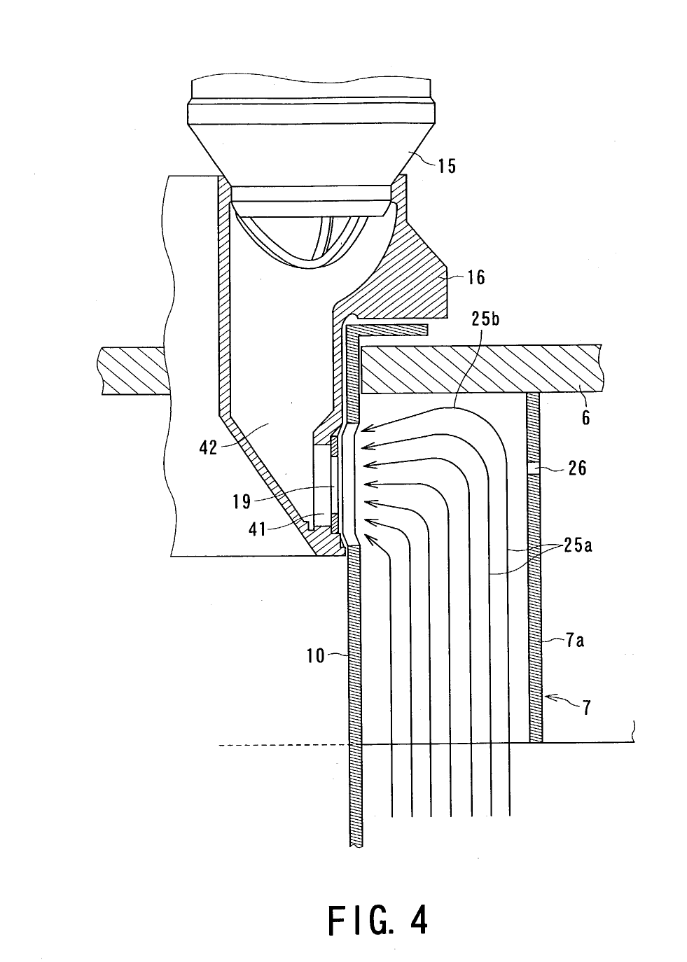

Second Embodiment (FIG. 4)

FIG. 4 is a vertical cross-sectional view of a core inlet structure for coolant, according to the second embodiment of the present invention, illustrating flow of the coolant directed toward an inlet orifice thereof in the passage section.

In the second embodiment, one of the pair of beam plates 7a of the reinforcing beam 7, which are at right angles to each other, is provided with a single through-hole 26. Alternatively, a plurality of through-holes 26 may be provided in the one of the pair of the beam plates 7a. Each of the beam plates 7a may be provided with at least one through-hole 26, provided that the through-hole(s) 26 formed in the one of the beam plates 7a is not symmetrical to the through-hole(s) 26 in the other of the beam plates 7a, which is at right angles to the former beam plates 7a, on the horizontal plane relative to the inlet orifice 19 that is placed in the corner at which the pair of beam plates 7a intersect at right angles to each other.

According to such a structure, a passage area in a position corresponding to the through-hole 26 is expanded equivalently and the coolant comes in and out through the through-hole 26, resulting in disturbance of the current of the coolant, which is to collide with the core support plate 6, and symmetry of the flow of the coolant on the horizontal plane relative to the inlet orifice 19 will be lost. As a result, swirls occurring in positions becomes asymmetric. In the vortex having such asymmetric shape, the vortex condition, due to the slight change of the passage, less changes in comparison with the vortex having the symmetric shape. Slightly modified shape of the passage causes little change of the vortex condition, and it is avoided to change the passage pressure loss factor of the inlet orifice 19. Consequently, it is possible to adjust the flow rate of-the coolant flowing into the fuel assembly 17 in an appropriate manner.

According to the second embodiment of the present invention, occurrence of swirls is controlled, thus making it possible to adjust appropriately the flow rate of the coolant flowing into the fuel assembly through the inlet orifice.

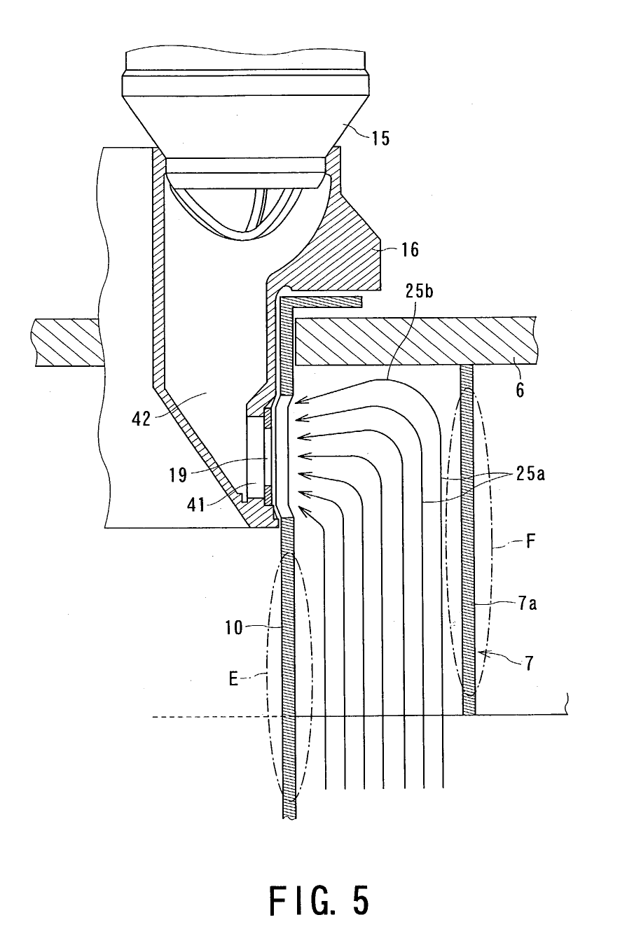

Third Embodiment (FIG. 5 to FIG. 6B)

FIG. 5 is a vertical cross-sectional view of the core inlet structure for coolant, according to the third embodiment of the present invention, illustrating flow of the coolant directed toward the inlet orifice thereof in the passage section. FIG. 6A is an enlarged cross-sectional view of a portion “E” in FIG. 5 and FIG. 6B is an enlarged cross-sectional view of the portion “E” as modified.

In the third embodiment, turbulence occurs in the ascending current of the coolant, which has not as yet collided with the core support plate 6 and the center of the inlet orifice 19, which face in the horizontal direction, is shifted to the upper position, so as to control the flow descending in the vicinity of the inlet orifice 19.

More specifically, in the third embodiment, at least one of the control rod guide pipe 10 and the beam plate 7a of the reinforcing beam 7, which forms the passage, is provided in the middle portion thereof represented by the symbols “E” and “F” in FIG. 5 with a vortex control device that is obtained by applying a surface machining process to the surface of the above-mentioned middle portion.

The surface machining process is carried out to form fine irregularities 31 on the surface of at least one of the control rod guide pipe 10 and the beam plate 7a of the reinforcing beam 7, thus providing a predetermined surface roughness by which the surface is coarsened. Alternatively, at least one of the control rod guide pipe 10 and the beam plate 7a of the reinforcing beam 7 is provided on its surface with grooves 32 formed thereon. Such a structure provides on the corresponding portion of at least one of the control rod guide pipe 10 and the beam plate 7a of the reinforcing beam 7 with the surface roughness of for example 25 μm or more.

The above-described structure makes it possible to attenuate the turning current moving toward the inlet orifice 19, thus controlling occurrence of swirls. More specifically, while using a normally designed core inlet structure, in which the beam plate 7a of the reinforcing beam 7 of the core support plate or the control rod guide pipe 10 has a surface roughness of about 2.5 μm, leads to recognition of occurrence of swirls due to the above-mentioned turning current. According to this third embodiment, it is possible to control the occurrence of swirls.

Coarsening the surface of the beam plate 7a of the reinforcing beam 7 and the control rod guide pipe 10 facilitates occurrence of turbulence of flow so as to attenuate the descending current of coolant in the vicinity of the inlet orifice 19. As a result, the occurrence of such swirls can be controlled and increase in the ratio of passage pressure loss factor due to the occurrence of the swirl in the vicinity of the inlet orifice 19 can be avoided, thus providing the stable ratio of passage pressure loss factor.

According to the third embodiment of the present invention, occurrence of swirls is controlled, thus making it possible to adjust appropriately the flow rate of the coolant flowing into the fuel assembly through the inlet orifice.

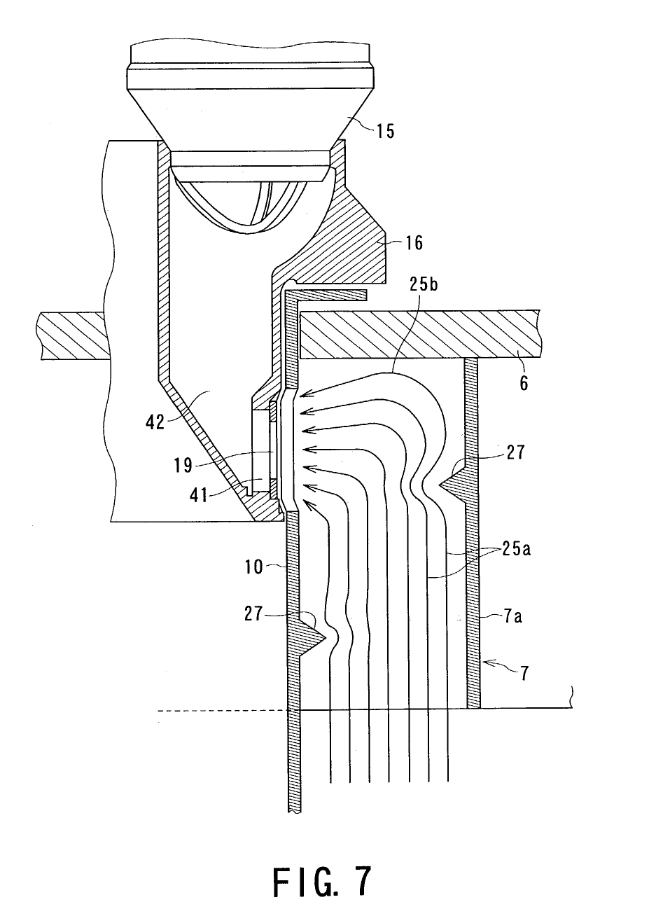

Fourth Embodiment (FIG. 7)

FIG. 7 is a vertical cross-sectional view of the core inlet structure for coolant, according to the fourth embodiment of the present invention, illustrating flow of the coolant directed toward the inlet orifice thereof in the passage section.

In the fourth embodiment, turbulence occurs in the ascending current of the coolant, which has not as yet collided with the core support plate 6, so as to control the occurrence of swirls. More specifically, there is provided a structure that formation of a projection 27, which serves as the vortex control device, on the surface of at least one of the beam plate 7a of the reinforcing beam 7 and the control rod guide pipe 10 facilitates occurrence of turbulence so as to attenuate the turning current moving toward the inlet orifice 19.

The above-described structure enables the current of coolant ascending in the passage to be stirred to facilitate the occurrence of turbulence so as to control the occurrence of swirls in the vicinity of the inlet orifice 19. As a result, increase in the ratio of passage pressure loss factor due to the occurrence of the swirl in the vicinity of the inlet orifice 19 can be avoided.

According to this fourth embodiment of the present invention, the occurrence of swirls is controlled, thus making it possible to adjust appropriately the flow rate of the coolant flowing into the fuel assembly through the inlet orifice.

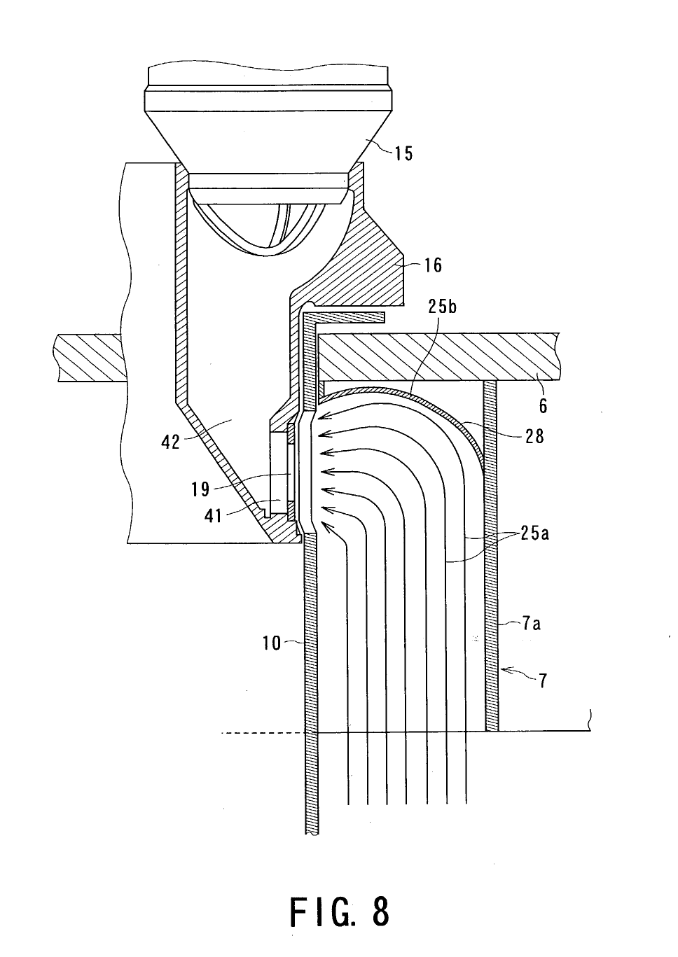

Fifth Embodiment (FIG. 8)

FIG. 8 is a vertical cross-sectional view of the core inlet structure for coolant, according to the fifth embodiment of the present invention, illustrating flow of the coolant directed toward the inlet orifice thereof in the passage section.

In the fifth embodiment, the ascending current 25a of the coolant is caused to flow smoothly into the inlet orifice 19 so as to control the occurrence of swirls.

More specifically, a deflecting plate 28, that serves as the cortex control device and has a curved surface with its edge directed to the periphery of the inlet orifice 19, is disposed below the core support plate 6 facing the inlet orifice 19 so as to make the current of coolant smooth, thus attenuating the descending current of coolant in the horizontal vicinity of the inlet orifice 19 to control the occurrence of swirls.

According to this fifth embodiment of the present invention, occurrence of swirls is controlled, thus making it possible to adjust appropriately the flow rate of the coolant flowing into the fuel assembly through the inlet orifice.

In the fifth embodiment as illustrated in FIG. 8, the vortex control device is composed of the single deflecting plate 28 having the curved surface. The vortex control device may however be composed of a plurality of deflecting plates or like.

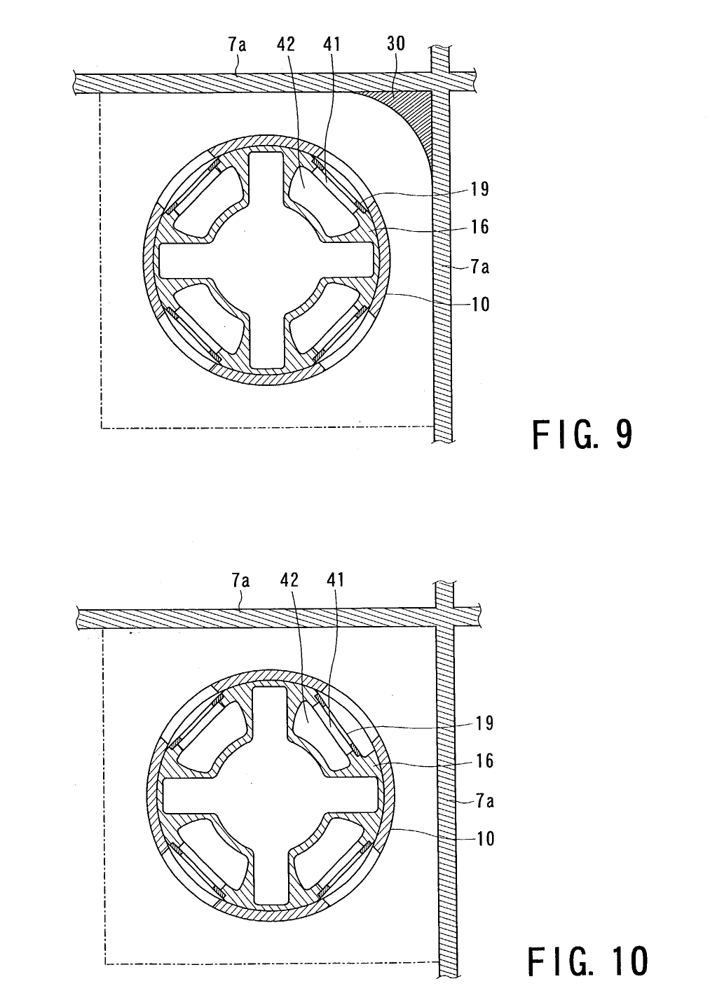

Sixth Embodiment (FIG. 9)

FIG. 9 is a horizontal cross-sectional view of the core inlet structure for coolant, according to the sixth embodiment of the present invention, illustrating flow of the coolant directed toward the inlet orifice thereof in the passage section.

In the sixth embodiment, a deflecting member 30, which serves as the vortex control device and has a curved surface facing the inlet orifice 19, is disposed in the corner at which the pair of beam plates 7a of the reinforcing beam 7 intersect at right angles to each other.

The deflecting plate 30 as disposed in the corner position mentioned above converts the space having a rectangular outer periphery, which is defined by the control rod guide pipe 10 and the beam plates 7a in the vicinity of the inlet orifice on the horizontal plane, into the modified space having a rounded outer periphery, which is defined by the control rod guide pipe 10 and the curved surface of the deflecting plate 30. As a result, the flow rate of the coolant ascending in a zone between the control rod guide pipe 10 and the corner portion at which the pair of beam plates 7a intersect at right angles to each other becomes substantially equal to that of the coolant ascending in the remaining zone. Such a structure can attenuate the current of coolant descending in the vicinity of the inlet orifice 19, thus controlling the occurrence of swirls.

According to the sixth embodiment of the present invention, the occurrence of swirls is controlled, thus making it possible to adjust appropriately the flow rate of the coolant flowing into the fuel assembly through the inlet orifice.

In the sixth embodiment as illustrated in FIG. 9, the deflecting pate 30 has the curved surface. The deflecting plate 30 may have a flat surface, provided that the deflecting plate 30 converts the space having a rectangular outer periphery, which is defined by the control rod guide pipe 10 and the beam plates 7a in the vicinity of the inlet orifice on the horizontal plane, into the modified space having an outer periphery similar to the rounded shape.

Seventh Embodiment (FIG. 10)

FIG. 10 is a horizontal cross-sectional view of the core inlet structure for coolant, according to the seventh embodiment of the present invention, illustrating flow of the coolant directed toward the inlet orifice thereof in the passage section.

In the seventh embodiment, the central axis of the inlet orifice 19 deviates from a diagonal line from the corner at which the pair of beam plates 7a intersect at right angles to each other so that possible swirls occur in positions, which are not symmetrical to each other relative to the central axis of the inlet orifice 19.

In the conventional prior art, the central axis of the inlet orifice 19 coincides with the diagonal line from the corner at which the pair of beam plates 7a intersect at right angles to each other so that twin swirls tend to occur at positions, which are symmetrical to each other relative to the central axis of the inlet orifice 19. A slight change in shape of the passage has an influence on the twin swirls to make a change in state thereof, thus providing an unstable ratio of passage pressure loss factor due to the occurrence of the swirl in the vicinity of the inlet orifice 19 and hence being not available.

In the seventh embodiment, however, the deviation of the central axis of the inlet orifice 19 from a diagonal line from the corner, at which the pair of beam plates 7a intersect at right angles to each other, makes it possible to cause possible swirls to occur in positions, which are not symmetrical to each other relative to the central axis of the inlet orifice 19. Such a slightly modified shape of the passage permits to avoid change in the ratio of passage pressure loss factor of the inlet orifice 19.

According to this seventh embodiment of the present invention, the slightly modified shape of the passage, which causes the possible swirls to occur in positions, which are not symmetrical to each other relative to the central axis of the inlet orifice 19, permits to avoid change in the ratio of passage pressure loss factor of the inlet orifice 19, thus making it possible to adjust appropriately the flow rate of the coolant flowing into the fuel assembly through the inlet orifice.

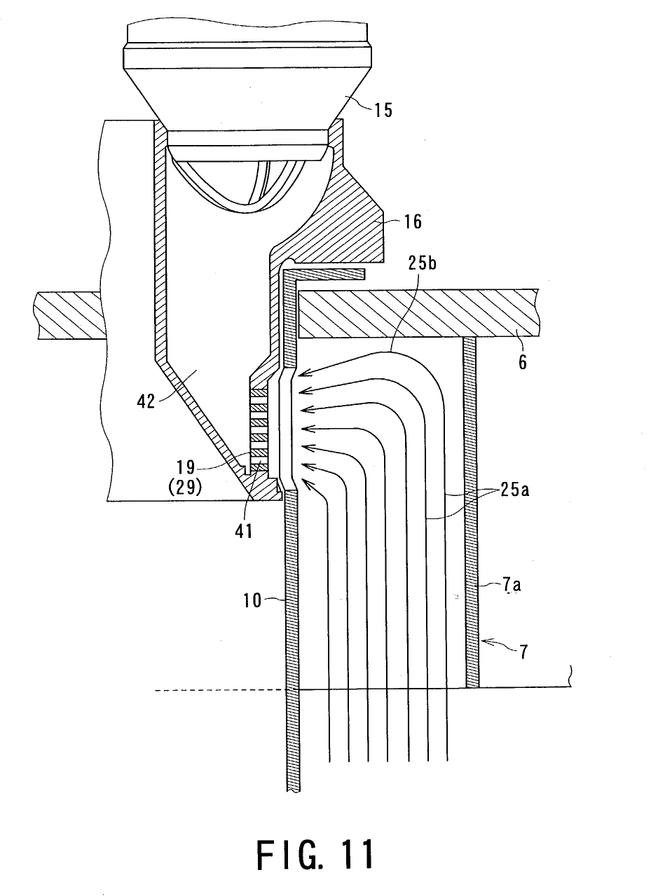

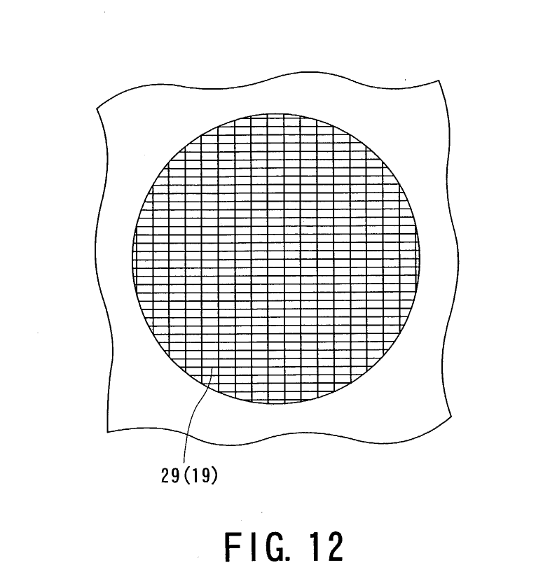

Eighth Embodiment (FIGS. 11 and 12)

FIG. 11 is a vertical cross-sectional view of the core inlet structure for coolant, according to the eighth embodiment of the present invention, illustrating flow of the coolant directed toward the inlet orifice thereof in the passage section and FIG. 12 is an enlarged side view illustrating the inlet orifice as shown in FIG. 11.

In the eighth embodiment, the inlet orifice 19 is provided in the opening thereof with a flow distributing member 29 in the form of net or perforated plate.

The coolant flows into the flow distributing member 29 in a dispersed state, thus disabling the coolant from entering the flow distributing member 29 in the form of a large-scaled swirl. In addition, the vorticity of the large-scaled swirl is remarkably attenuated until it reaches the flow distributing member 29, with the result that the vorticity of swirls, which occur on the upstream side of the flow distributing member 29 is also attenuated. The turning energy of the swirls, which are to come into the flow distributing member 29, therefore becomes smaller, thus avoiding the increase in the ratio of passage pressure loss factor in the flow distributing member 29.

According to the eighth embodiment of the present invention, making the turning energy of the swirls small, which are to come into the flow distributing member 29, controls change in the ratio of passage pressure loss factor in the flow distributing member. It is therefore possible to adjust the flow rate of the coolant flowing into the fuel assembly in an appropriate manner, by the flow distributing member.

The present invention is not limited only to the shape as illustrated of the flow distributing member 29 and the shape thereof may be changed.

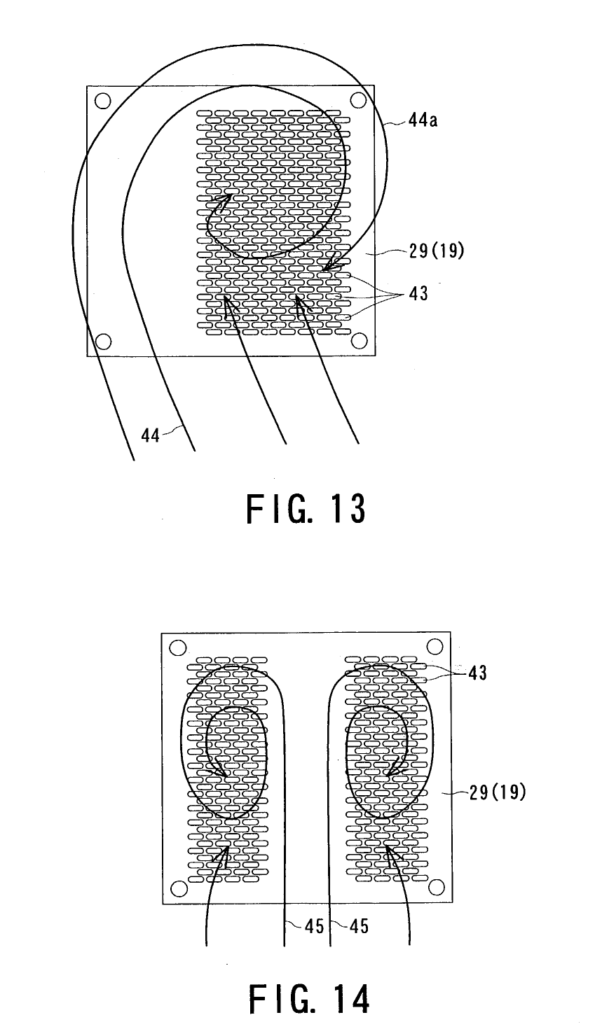

Ninth Embodiment (FIG. 13)

FIG. 13 illustrates the ninth embodiment of the present invention and is a descriptive view illustrating a modification of the flow distributing member 29 as described in the eighth embodiment. The structure for mounting the flow distributing member 29 on the fuel support member 16 is basically identical to that generally shown in FIG. 11, and the description of such a structure is therefore omitted here.

In the ninth embodiment, the flow distributing member 29 has coolant-flowing holes 43 so that the center of the area in which the coolant-flowing holes are formed deviates from the central position of the inlet orifice 19 provided in a coolant-inlet of the fuel support member 16, as shown in FIG. 13, thus providing an asymmetrical position of the area of the coolant-flowing holes relative to the central position of the inlet orifice 19. More specifically, the center of the inlet orifice 19 is placed on a straight line connecting the corner at which the pair of beam plates 7a intersect at right angles to each other, with the center of the fuel support member 16, and the area in which the coolant-flowing holes 43 are formed is not symmetrical relative to the above-mentioned straight line connecting the corner at which the pair of beam plates 7a intersect at right angles to each other, with the center of the fuel support member 16. In the illustrated example, the flow distributing member 29 is placed vertically so that the center of the area in which the coolant-flowing holes 43 are formed deviates from the central position of the inlet orifice 19 toward one of the right and right-hand sides in the horizontal direction.

Such a structure in which the center of the area in which the coolant-flowing holes 43 are formed deviates from the central position of the inlet orifice 19 toward one of the right and right-hand sides in the horizontal direction, so as not to be symmetrical relative to the central position of the inlet orifice 19, contributes to the formation of the single swirl, rather than twin swirls. Even if the twin swirls occur, the positions thereof are not symmetrical to each other relative to the central axis of the inlet orifice 19.

Flow tests, in which the simulated shapes of the flow distributing member 29 as actually used were applied, revealed observation of the formation of such swirls. Although the conventional structure leads to the occurrence of the twin swirls, the present embodiment leads to the occurrence of the single swirl. Accordingly, the slightly modified shape of the passage makes it possible to avoid change in state of the occurrence of swirl and the increase in the ratio of passage pressure loss factor in the flow distributing member 29.

According to the ninth embodiment of the present invention, the possible swirls occur in positions, which are not symmetrical to each other in the above-described positional relationship. Such a slightly modified shape of the passage permits to avoid change in the ratio of passage pressure loss factor in the flow distributing member 29. Consequently, it is possible to adjust the flow rate of the coolant flowing into the fuel assembly in an appropriate manner, by the flow distributing member.

Tenth Embodiment (FIG. 14)

FIG. 14 illustrates the tenth embodiment of the present invention and is a descriptive view illustrating another modification of the flow distributing member 29 as described in the eighth embodiment. The structure for mounting the flow distributing member 29 on the fuel support member 16 is basically identical to that generally shown in FIG. 11. Description of such a structure is therefore omitted.

In the tenth embodiment, the flow distributing member 29 has a pair of areas, which are symmetrical to each other relative to the central position of the inlet orifice 19 formed in the fuel support member 16, as shown in FIG. 14, and the coolant-flowing holes 43 are formed in each of the above-mentioned pair of areas. The tenth embodiment however has the specific structure that the distance between the adjacent coolant-flowing holes 43 formed in one of the pair of areas is larger than that between the adjacent coolant-flowing holes 43 formed in the other thereof.

In the above-described structure, although the twin swirls 45 occurs in the same manner as the eighth embodiment, difference in distance between the adjacent coolant-flowing holes 43 exists between the pair of areas as mentioned above. Such a slightly modified shape of the passage does not lead to change in the state of occurrence of swirls. Consequently, such a slightly modified shape of the passage does not increase the ratio of passage pressure loss factor in the flow distributing member 29.

According to this tenth embodiment of the present invention, by stabilizing the state of occurrence of the swirls the change in the ratio of passage pressure loss factor in the flow distributing member 29 can be controlled, thus making it possible to adjust the flow rate of the coolant flowing into the fuel assembly in an appropriate manner, by the flow distributing member.

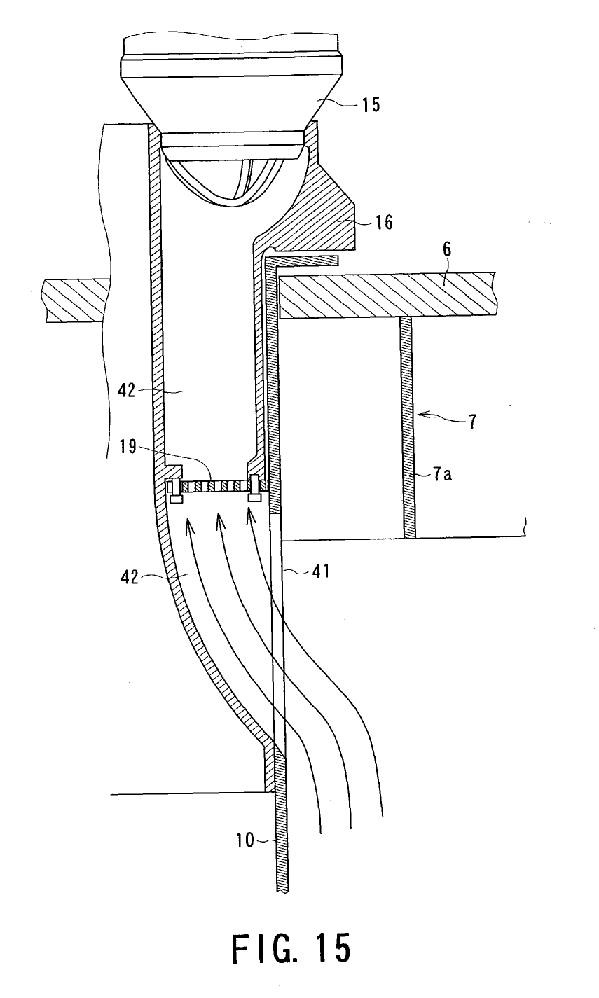

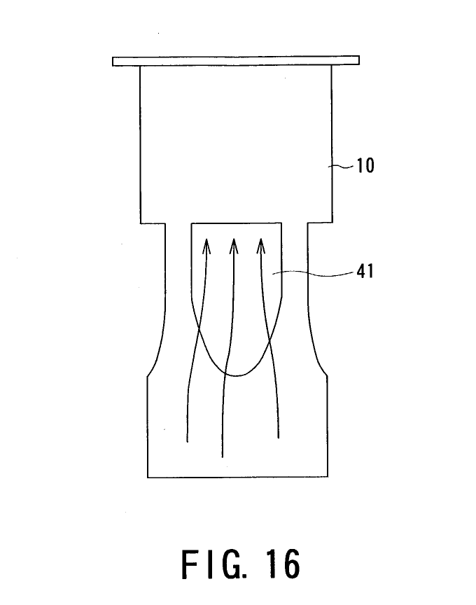

Eleventh Embodiment (FIGS. 15 and 16)

FIG. 15 is a vertical cross-sectional view of the core inlet structure for coolant, according to the eleventh embodiment of the present invention, illustrating flow of the coolant directed toward the inlet orifice thereof in the passage section and FIG. 16 is a side view illustrating the inlet orifice as shown in FIG. 15.

In the eleventh embodiment, the coolant inlet 41 of the fuel support member 16 is disposed so that the lower end thereof is placed below the lower end of the reinforcing beam 7 and the fuel support member 16 is provided in a coolant passage 42 located therein with the inlet orifice 19. More specifically, one side of the inlet orifice 19 is supported on the inner surface of the coolant passage 42 of the fuel support member 16. Supporting the one side of the inlet orifice on the inner surface of the coolant passage 42 of the fuel support member 16 in this manner makes it possible to dispose the inlet orifice 19 substantially in the inside of the coolant passage 42 of the fuel support member 16, even if the other side of the inlet orifice 19 is supported on the coolant inlet 41 of the fuel support member 16.

In the example as illustrated, the coolant inlet 41 has an elongated shape extending vertically. The lower end of the coolant inlet 41 is placed below the lower end of the reinforcing beam 7. The control rod guide pipe 10 is also provided with holes formed therein, which have the same shape as the coolant inlet 41.

The inlet orifice 19, which is to be provided in the inside of the coolant passage 42, is formed of a perforated plate having a plurality of small orifice holes. Alternatively, there may be adopted a multiple orifice structure in which the plate having a normal circular orifice hole is formed on the perforated plate. The inlet orifice 19 having such a structure provides the same function as that of the flow distributing member 29 as described above.

In the structure as described above of the eleventh embodiment, the coolant inlet 41 has the elongated shape extending vertically, the lower end of the coolant inlet 41 is placed below the lower end of the reinforcing beam 7 and the coolant inlet 41 has a large cross sectional area of the passage so that the coolant smoothly flows into the fuel support member 16 in a state in which occurrence of the swirl as mentioned above can be controlled appropriately. In addition, since there is a relatively long distance between. the inlet orifice 19 and the passage, in which the swirl tends to occur and which is defined by the control rod guide pipe 10 and the beam plates 7a of the reinforcing beam 7, an additional effect of attenuating the vorticity of the swirl can be realized during a period of time that lapses until the swirl reaches the inlet orifice 19 after the occurrence of the swirl.

According to the eleventh embodiment of the present invention, the vorticity of the swirl, which is to flow into the inlet orifice 19, can be attenuated and the slightly modified shape of the passage makes it possible to avoid change in the ratio of passage pressure loss factor in the inlet orifice 19. It is therefore possible to adjust the flow rate of the coolant flowing into the fuel assembly in an appropriate manner, by the inlet orifice 19.

The feature of utilizing the perforated plate as the inlet orifice 19, the feature of providing the inlet orifice 19 in the coolant passage 42 located in the inside of the fuel support member 16 and the feature of placing the lower end of the coolant inlet 41 of the fuel support member 16 below the lower end of the reinforcing beam 7 will attain a synergic effect in attenuation of the vorticity of the swirl when entering the inlet orifice 19. Each of the above-mentioned features independently has the effect of attenuating the vorticity of the swirl when entering the inlet orifice 19. Accordingly, it is possible to apply these features alone or in combination.

When the inlet orifice is placed in a lower tie plate 15, it is possible to increase the distance between the inlet orifice and the passage in which the swirl tends to occur and which is defined by the control rod guide pipe 10 and the beam plates 7a of the reinforcing beam 7, so as to attenuate the vorticity of the swirl during a period of time that lapses until the swirl reaches the inlet orifice after the occurrence of the swirl. A replacing operation is applied to the lower tie plate 15 together with the fuel assembly 17. Accordingly, the inlet orifice has to be replaced with the new one every time the fuel assembly 17 is replaced with the new one, thus causing uneconomical matters in material and manufacture. There may be a case where change is made in position of the fuel assembly 17 in the core during operation. More specifically, the fuel assembly 17 may be shifted from a position, which corresponds to the corner at which the pair of beam plates 7a intersect at right angles to each other, to another position, which does not correspond to the above-mentioned corner. As a result, there is required a replacing operation of the inlet orifice, along with the shifting operation of the fuel assembly 17 in the core, thus causing inconvenient problems.

On the contrary, the fuel support member is subjected to neither replacing operation, nor shifting operation, along with the replacement of the fuel assembly 17. As a result, when the inlet orifice is mounted on the fuel support member, it is unnecessary to replace the inlet orifice, irrespective of replacement of the fuel assembly 17.

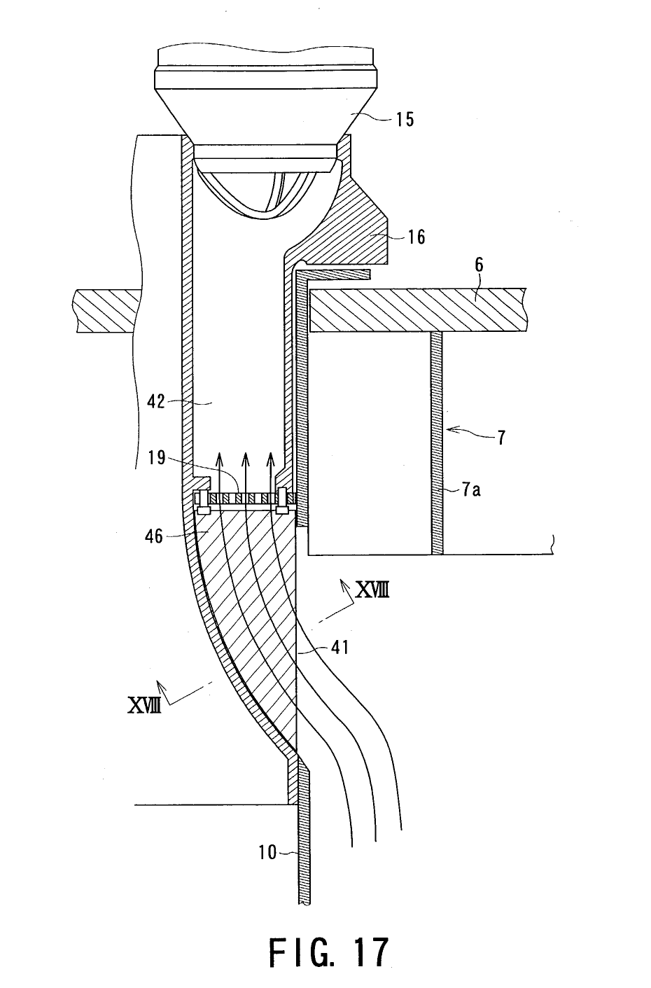

Twelfth Embodiment (FIGS. 17 to 19)

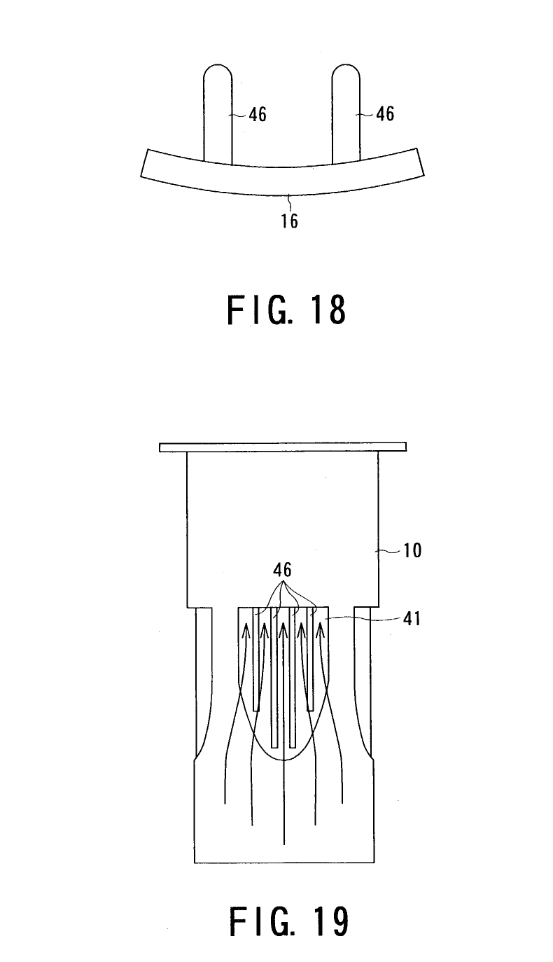

FIG. 17 is a vertical cross-sectional view of the core inlet structure for coolant, according to the twelfth embodiment of the present invention, illustrating flow of the coolant directed toward the inlet orifice thereof in the passage section and FIG. 18 is an enlarged cross-sectional view cut along the line XVIII-XVIII in FIG. 17. FIG. 19 is a side view illustrating the inlet orifice as shown in FIG. 17.

In the twelfth embodiment, there are provided a plurality of vortex control plates 46 composed of parallel vertical plates, so as to extend from the coolant inlet 41 of the fuel support member 16 toward the inside of the coolant passage 42, in addition to the same structural components as those described with reference to the eleventh embodiment. The other structural components are identical to those as described in the eleventh embodiment and the description of them will therefore be omitted.

The vortex control plates 46 are placed in parallel with each other at equal intervals as shown in FIG. 17. The vortex control plates 46 are secured for example means of welding on the inner surface of the coolant passage 42, which face the coolant inlet 41 of the fuel support member 16, so that the vortex control plates 46 are placed along the flowing direction of the coolant.

In this twelfth embodiment, providing the above-mentioned vortex control plates 46 causes the coolant entering from the coolant inlet 41 to flow smoothly and parallelly in the single direction in the fuel support member 16. This makes it possible to attenuate the vorticity of the swirl when entering the inlet orifice 19. Such a slightly modified shape of the passage permits to avoid change in the ratio of passage pressure loss factor of the inlet orifice 19.

According to the twelfth embodiment of the present invention, the slightly modified shape of the passage makes it possible to avoid change in the ratio of passage pressure loss factor in the inlet orifice 19. It is therefore possible to adjust the flow rate of the coolant flowing into the fuel assembly in an appropriate manner, by the inlet orifice 19.

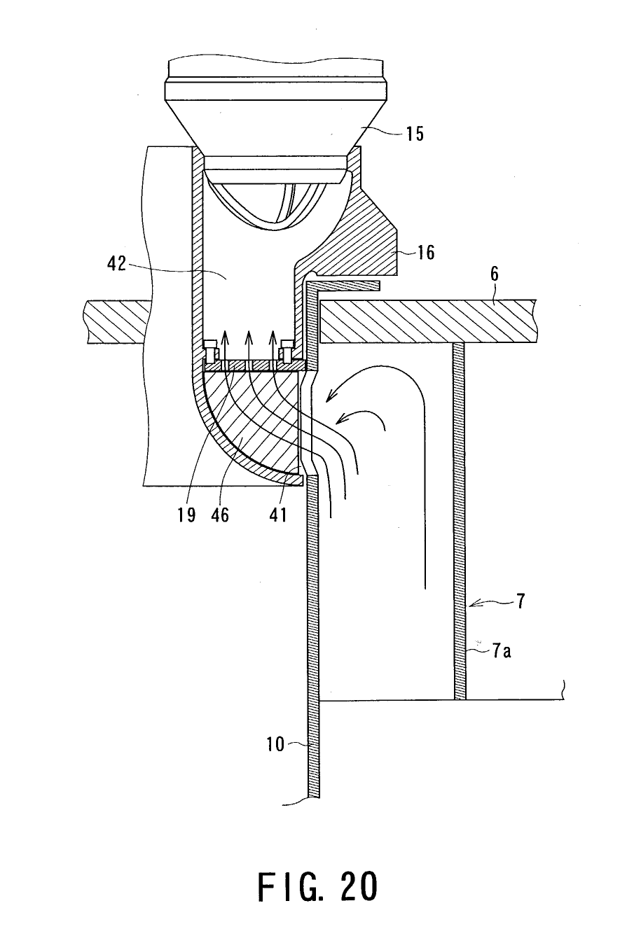

Thirteenth Embodiment (FIGS. 20 to 23)

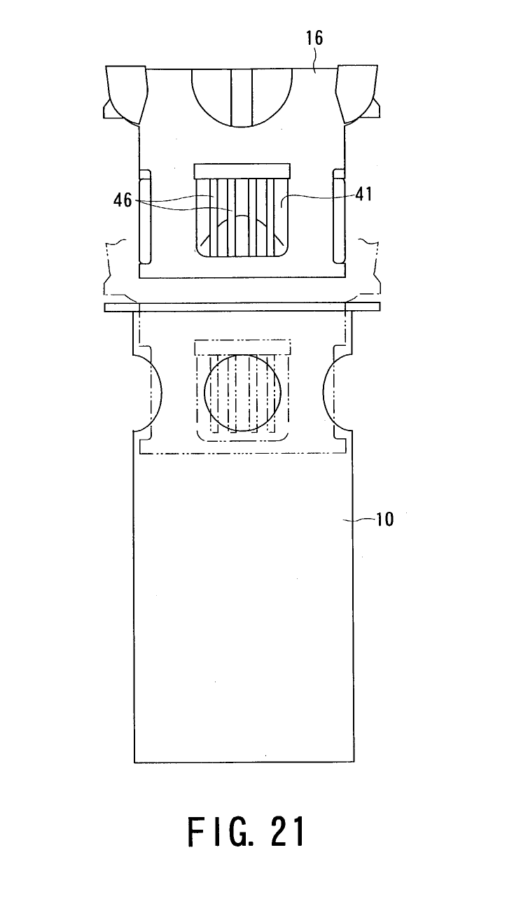

FIG. 20 is a vertical cross-sectional view of the core inlet structure for coolant, according to the thirteenth embodiment of the present invention, illustrating flow of the coolant directed toward the inlet orifice thereof in the passage section. FIG. 21 is a side view illustrating the inlet orifice as shown in FIG. 20. FIG. 21 shows a state in which the fuel support member 16 is removed upwardly from the control rod guide pipe 10.

In this thirteenth embodiment, the coolant inlet 41 of the fuel support member 16 is arranged so that the lower end thereof is positioned above the lower end of the reinforcing beam 7 and the fuel support member 16 is provided therein with the inlet orifice 19. In the example as shown in FIGS. 20 and 21, the fuel support member 16 has the same external appearance as that of the conventional structure, but the inlet orifice 19 is placed horizontally in the coolant passage 42. There are also provided a plurality of vortex control plates 46 composed of parallel vertical plates so as to extend from the coolant inlet 41 of the fuel support member 16 toward the inside of the coolant passage 42 in the same manner as the twelfth embodiment.

According to such a structure, which modifies only the structure of the fuel support member 16 to place the inlet orifice 19, which has an orifice structure with a plurality of holes, in the inside of the fuel support member 16 produces an effect of attenuating the vorticity of the swirl accompanied with the coolant flowing in the inlet orifice 19 having the above-mentioned orifice structure, the disposing of the inlet orifice 19 in the inside of the fuel support member 16 produces an effect of attenuating the vorticity of the swirl accompanied with the coolant flowing in the inlet orifice 19 and the placing of the vortex control plates 46 produces an effect of attenuating the vorticity of the swirl accompanied with the coolant flowing in the inlet orifice 19, thus providing a stable ratio of passage pressure loss factor in the inlet orifice 19.

According to this thirteenth embodiment of the present invention, the slightly modified shape of the passage makes it possible to avoid change in the ratio of passage pressure loss factor in the inlet orifice 19. It is therefore possible to adjust the flow rate of the coolant flowing into the fuel assembly in an appropriate manner by the inlet orifice 19. In addition, the thirteenth embodiment of the present invention has an advantage that the predetermined effects can be obtained without a remarkable revision of the conventional plant.

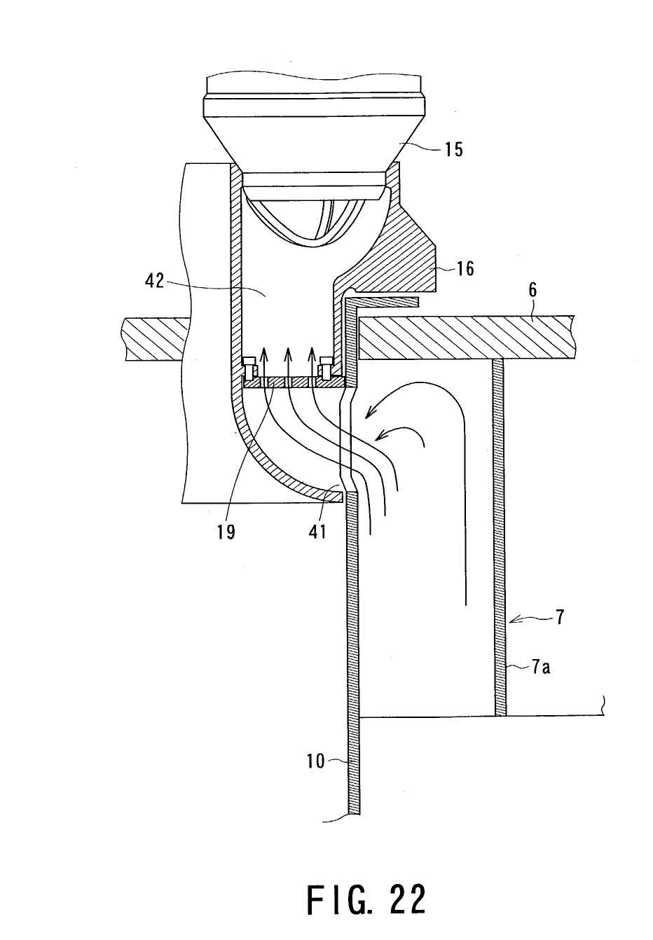

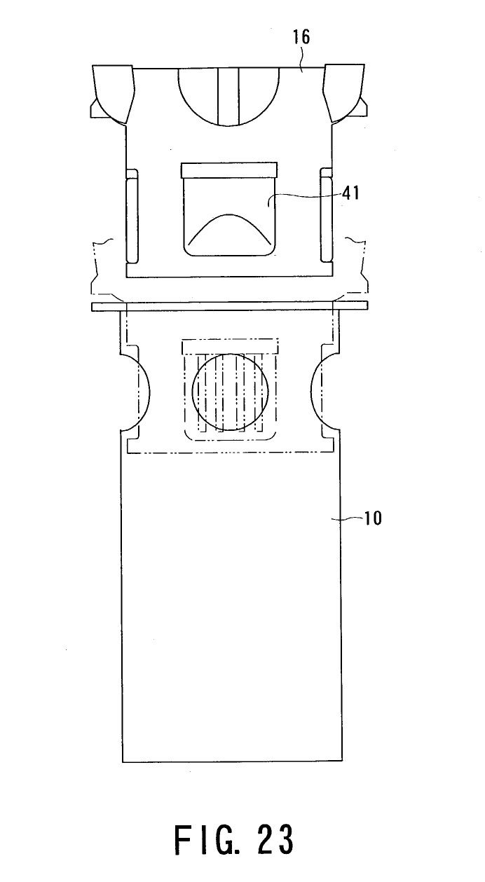

It is also possible to avoid change in the ratio of passage pressure loss factor in the inlet orifice 19, through a slightly modified shape of the passage, for example of the orifice structure with the plurality of holes, to adjust the flow rate of the coolant flowing into the fuel assembly in an appropriate manner, by the inlet orifice 19, even when the vortex control plates 46 are not provided as shown in FIGS. 22 and 23.

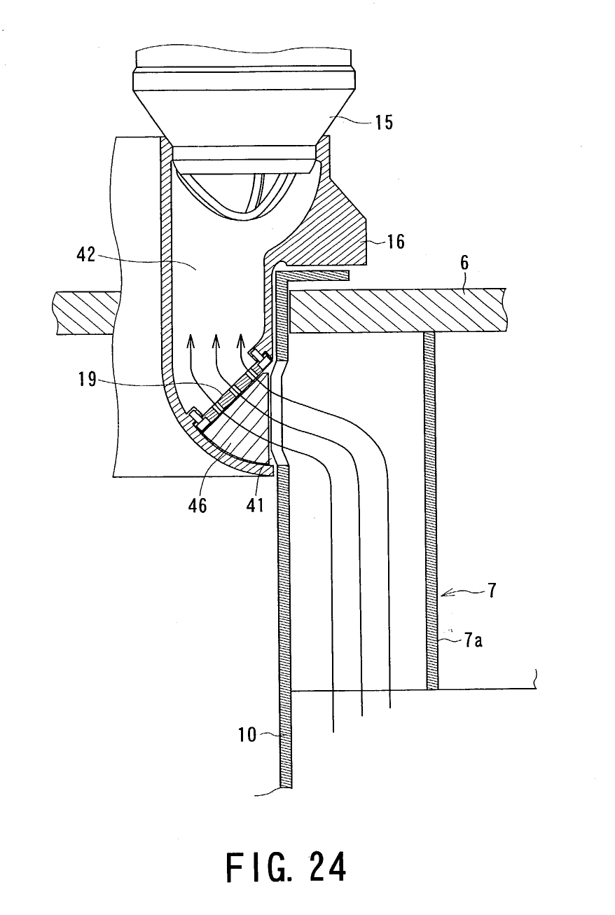

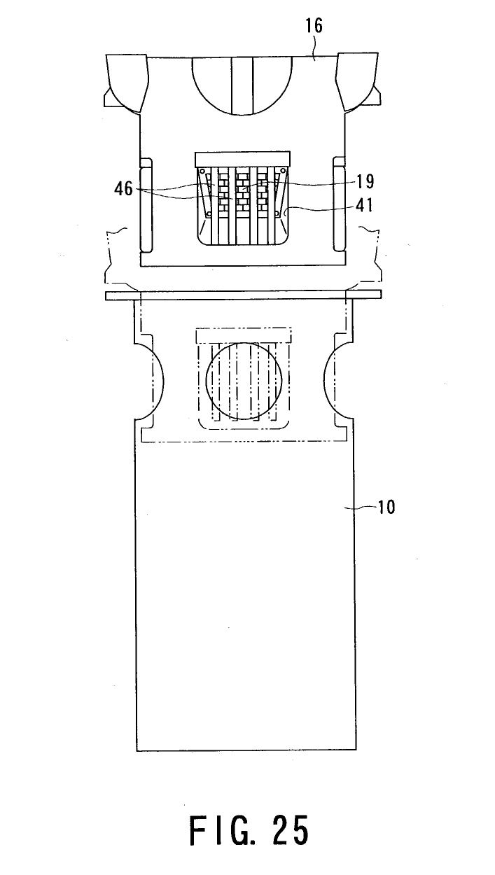

Fourteenth Embodiment (FIGS. 24 and 25)

FIG. 24 is a vertical cross-sectional view of the core inlet structure for coolant, according to the fourteenth embodiment of the present invention, illustrating flow of the coolant directed toward the inlet orifice thereof in the passage section. FIG. 25 is a side view illustrating the inlet orifice as shown in FIG. 24. FIG. 25 shows a state in which the fuel support member 16 is removed upwardly from the control rod guide pipe 10.

In the fourteenth embodiment, which is a modified one of the thirteenth embodiment, the inlet orifice 19 having the function as the orifice with a plurality of holes or the flow distributing member is disposed in the inside of the fuel support member 16 in an inclined state. The other structural components are substantially identical to those of the thirteenth embodiment, and the vortex control plates 46 are for example provided.

The cross-sectional area of the passage of the inlet orifice 19 can be increased by inclining it into consideration of the shape of the coolant passage 42 of the fuel support member 16.

According to the above-described structure of the fourteenth embodiment, by disposing the inlet orifice 19, which has the function as the orifice with the plurality of holes or the flow distributing member, in the inside of the fuel support member 16 in the inclined state, a large cross-sectional area of the passage of the inlet orifice 19 can be provided so as to ensure a sufficient flow rate of the coolant, while attenuating the vorticity of the swirl accompanied with the coolant flowing in the inlet orifice 19. Consequently, the slightly modified shape of the passage makes it possible to avoid change in the ratio of passage pressure loss factor in the inlet orifice 19. It is therefore possible to adjust the flow rate of the coolant flowing into the fuel assembly in an appropriate manner, by the inlet orifice 19.

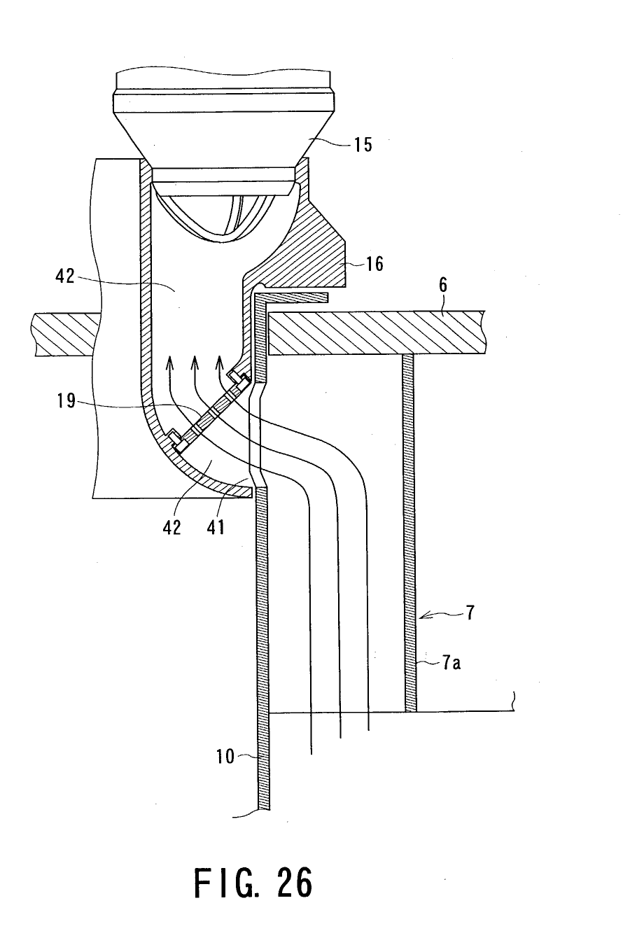

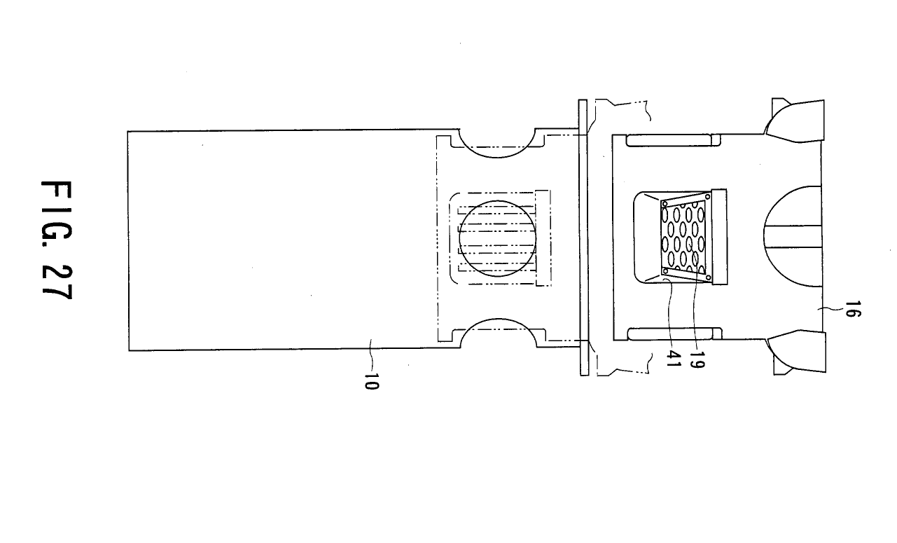

Fifteenth Embodiment (FIGS. 26 and 27)

FIG. 26 is a vertical cross-sectional view of the core inlet structure for coolant, according to the fifteenth embodiment of the present invention, illustrating flow of the coolant directed toward the inlet orifice thereof in the passage section. FIG. 27 is a side view illustrating the inlet orifice as shown in FIG. 26. FIG. 27 shows a state in which the fuel support member 16 is removed upwardly from the control rod guide pipe 10.

The fifteenth embodiment is obtained by excluding the vortex control plates 16 from the structure of the fourteenth embodiment. There is also provided the inlet orifice 19 having the function as the orifice with a plurality of holes or the flow distributing member.

According to the above-described structure of the fourteenth embodiment, by disposing the inlet orifice 19, which has the function as the orifice with the plurality of holes or the flow distributing member, in the inside of the fuel support member 16 in the inclined state, a large cross-sectional area of the passage of the inlet orifice 19 can be provided so as to ensure a sufficient flow rate of the coolant, while attenuating the vorticity of the swirl accompanied with the coolant flowing in the inlet orifice 19. Consequently, the slightly modified shape of the passage makes it possible to avoid change in the ratio of passage pressure loss factor in the inlet orifice 19. It is therefore possible to adjust the flow rate of the coolant flowing into the fuel assembly in an appropriate manner, by the inlet orifice 19.

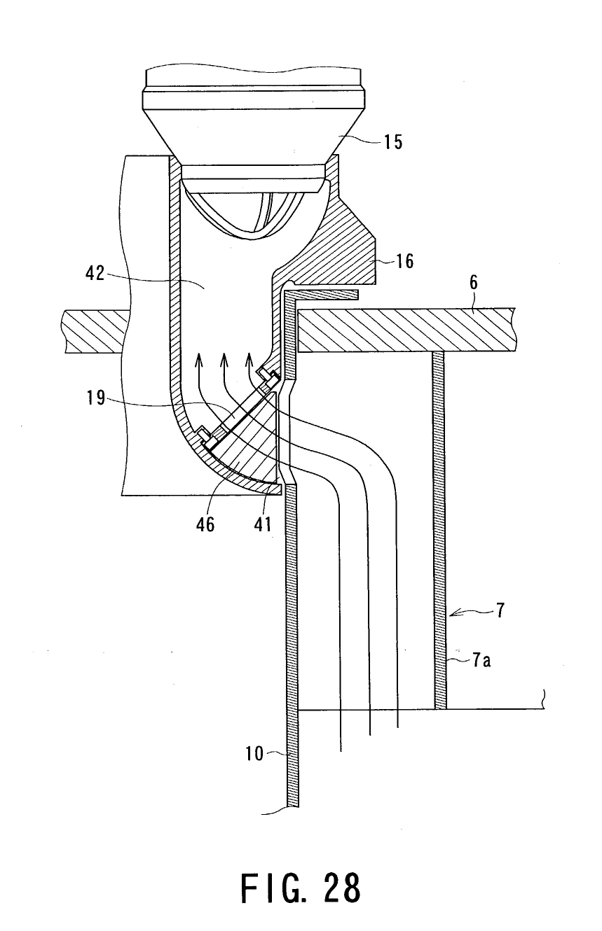

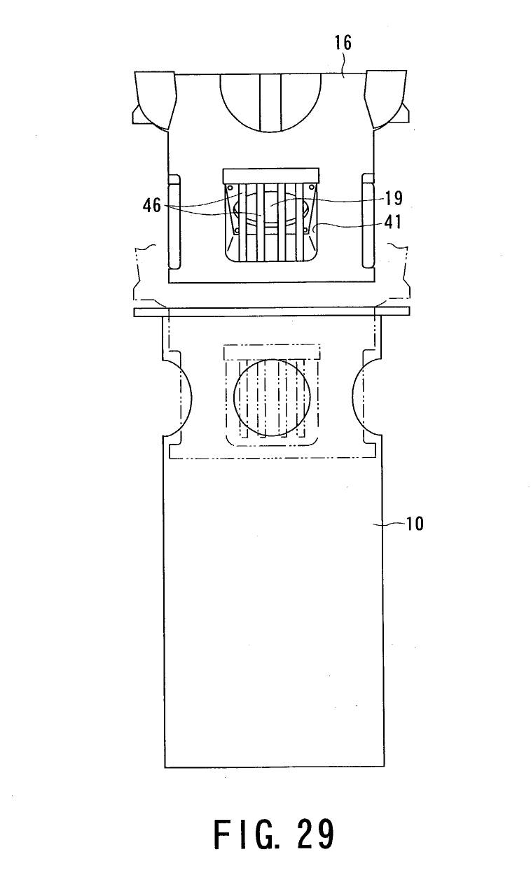

Sixteenth Embodiment (FIGS. 28 and 29)

FIG. 28 is a vertical cross-sectional view of the core inlet structure for coolant, according to the sixteenth embodiment of the present invention, illustrating flow of the coolant directed toward the inlet orifice thereof in the passage section. FIG. 29 is a side view illustrating the inlet orifice as shown in FIG. 28. FIG. 29 shows a state in which the fuel support member 16 is removed upwardly from the control rod guide pipe 10.

In the sixteenth embodiment, the orifice with the plurality of holes in the fourteenth embodiment is substituted with the normal orifice with a single hole.

According to the above-described structure of the sixteenth embodiment, by disposing the inlet orifice 19 in the inside of the fuel support member 16 in the inclined state, a large cross-sectional area of the passage of the inlet orifice 19 can be provided so as to ensure a sufficient flow rate of the coolant, while attenuating the vorticity of the swirl accompanied with the coolant flowing in the inlet orifice 19 under the function of the vortex control plates 46. Consequently, the slightly modified shape of the passage makes it possible to avoid change in the ratio of passage pressure loss factor in the inlet orifice 19. It is therefore possible to adjust the flow rate of the coolant flowing into the fuel assembly in an appropriate manner, by the inlet orifice 19.

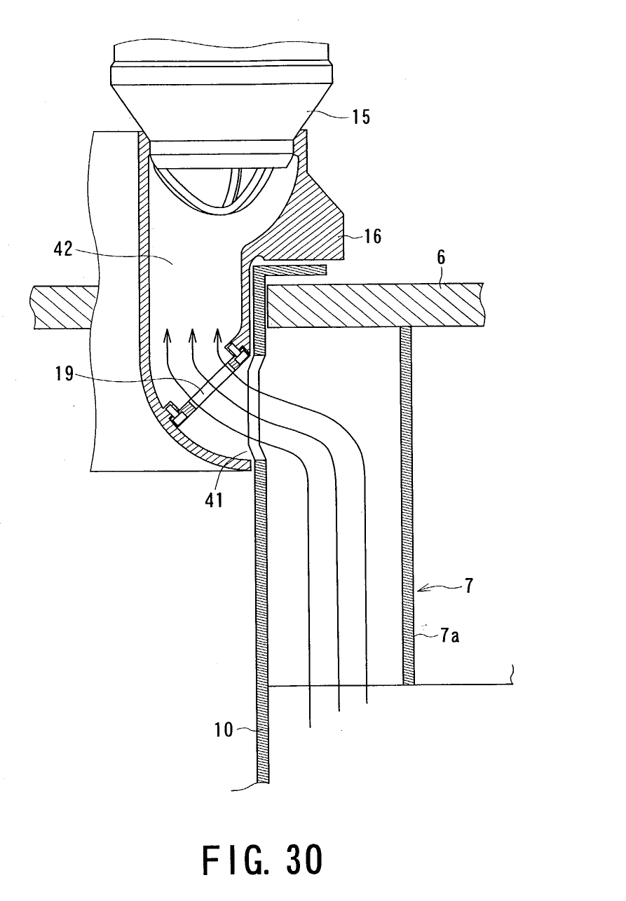

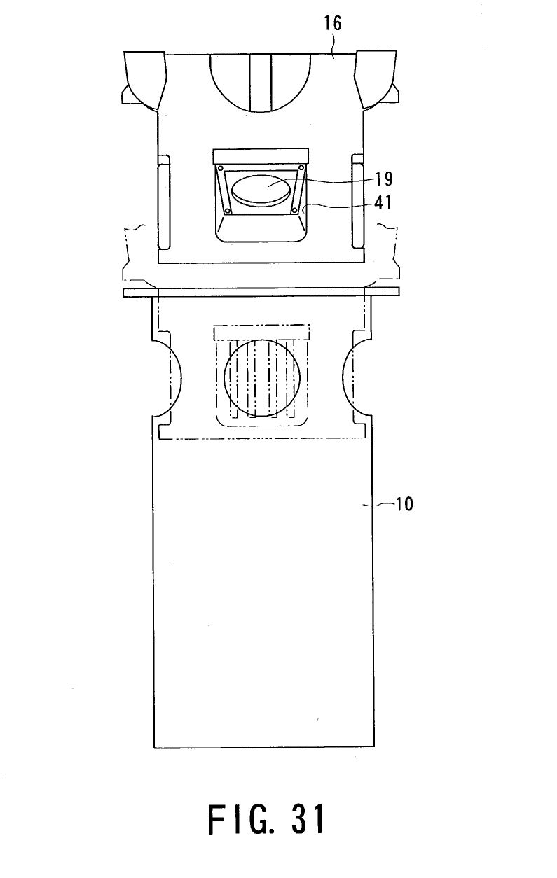

Seventeenth Embodiment (FIGS. 30 and 31)

FIG. 30 is a vertical cross-sectional view of the core inlet structure for coolant, according to the seventeenth embodiment of the present invention, illustrating flow of the coolant directed toward the inlet orifice thereof in the passage section. FIG. 31 is a side view illustrating the inlet orifice as shown in FIG. 30. FIG. 31 shows a state in which the fuel support member 16 is removed upwardly from the control rod guide pipe 10.

In the seventeenth embodiment, the orifice with the plurality of holes in the fourteenth embodiment is substituted with the normal orifice with a single hole.

According to the above-described structure of the seventeenth embodiment, by disposing the inlet orifice 19 in the inside of the fuel support member 16 in the inclined state, a large cross-sectional area of the passage of the inlet orifice 19 can be provided so as to ensure a sufficient flow rate of the coolant, while attenuating the vorticity of the swirl accompanied with the coolant flowing in the inlet orifice 19 under the function provided by disposing the inlet orifice 19 in the inside of the coolant passage 42 in the fuel support member 16. Consequently, the slightly modified shape of the passage makes it possible to avoid change in the ratio of passage pressure loss factor in the inlet orifice 19. It is therefore possible to adjust the flow rate of the coolant flowing into the fuel assembly in an appropriate manner, by the inlet orifice 19.

Other Embodiments

The present invention may be carried out not only in the form of either one of the first to seventeenth embodiments described above, but also in the form of further another embodiment that will be obtainable by combining any structural features of the above-described embodiments so as to provide synergic effects based on the specific effects of the above-described embodiments.

What is claimed is:

1. A core inlet structure for coolant disposed in a reactor pressure vessel of a boiling water reactor, comprising:
a core support plate provided with a plurality of fuel support holes;
a reinforcing beam supporting the core support plate from a lower portion thereof in an installed state of the reactor;
a plurality of control rod guide pipes standing perpendicularly upward from a bottom side of the reactor pressure vessel and having upper end portions fitted respectively to the fuel support holes formed to the core support plate;
a fuel support member inserted into upper end portions of the control rod guide pipes and supported by the core support plate vertically in the core so as to support lower end portions of fuel assemblies arranged in the core;
an inlet orifice formed to the fuel support member so as to adjust flow rate of a coolant flowing in the fuel assemblies; and
vortex control means for controlling vortex of the coolant flowing into the inlet orifice formed to the fuel support member, said vortex control means being provided in the core inlet structure at a portion except downstream from the inlet orifice.

2. A core inlet structure for coolant according to claim 1, wherein said vortex control means has a structure satisfying an equation L1D1≧1.7, in which L1 is a length from a lower end portion of the core support plate to a central position of the inlet orifice of the fuel support member and D1 is a typical diameter of an inlet passage, which is a value dividing a cross sectional area of a coolant rising flow by a sum of a circular-arc length of an outer surface of the control rod guide pipe assuming to constitute a coolant rising passage with respect to one inlet orifice and a horizontal length of the reinforcing beam surrounding the circular-arc length.

3. A core inlet structure for coolant according to claim 1, wherein said reinforcing beam comprises a plurality of beam plates which are connected in form of square lattice, one inlet orifice formed to the fuel support member is disposed so that an opened surface of the inlet orifice faces a corner portion at which beam plates of the reinforcing beam cross at right angle to each other, and said vortex control means has a structure in which a portion of the beam plate of the reinforcing member facing the inlet orifice of the fuel support member is formed with through holes asymmetric with respect to an intersecting line of the beam plates facing the inlet orifice of the fuel support member.

4. A core inlet structure for coolant according to claim 1, wherein said vortex control means has a structure in which at least one of the reinforcing beam and the control rod guide pipe has an increased surface roughness.

5. A core inlet structure for coolant according to claim 1, wherein said vortex control means has a structure in which at least one of the reinforcing beam and the control rod guide pipe is formed, to an outer surface thereof, with a groove or projection.

6. A core inlet structure for coolant according to claim 1, wherein said vortex control means comprises a deflection member deflecting the coolant flow towards the coolant inlet of the fuel support member, said deflection member being provided in the core inlet structure at a portion upstream from the inlet orifice.

7. A core inlet structure for coolant according to claim 6, wherein said inlet orifice is provided with a plurality of inlet ports.

8. A core inlet structure for coolant according to claim 7, wherein each of said inlet ports has a net-form structure.

9. A core inlet structure for coolant according to claim 7, wherein each of said inlet ports has a porous-plate-form structure.

10. A core inlet structure for coolant according to claim 1, wherein said reinforcing beam comprises a plurality of beam plates which are connected in form of square lattice, one inlet orifice formed to the fuel support member is disposed so as to face a corner portion at which the beam plates of the reinforcing beam cross at right angle to each other, and said vortex control means comprises a deflection member deflecting the coolant flow from the corner portion at which the beam plates of the reinforcing beam cross at right angle to each other, said deflection member being disposed to the corner portion.

11. A core inlet structure for coolant according to claim 1, wherein said reinforcing beam comprises a plurality of beam plates which are connected in form of square lattice, one inlet orifice formed to the fuel support member is disposed so that an opened surface of the inlet orifice faces a corner portion at which beam plates of the reinforcing beam cross at right angle to each other, and the opened surface of the inlet orifice facing the corner portion is inclined with respect to a line perpendicular to a line connecting a center of the fuel support member and an intersecting point of the beam plates facing the inlet orifice.

12. A core inlet structure for coolant according to claim 1, wherein said reinforcing beam comprises a plurality of beam plates which are connected in form of square lattice, one inlet orifice formed to the fuel support member is disposed so that an opened surface of the inlet orifice faces a corner portion at which beam plates of the reinforcing beam cross at right angle to each other, and a coolant inlet port formed to the inlet orifice facing the corner portion is disposed asymmetric with respect to a line connecting a center of the fuel support member and an intersecting point of the beam plates facing the inlet orifice of the fuel support member.

13. A core inlet structure for coolant according to claim 1, wherein said vortex control means comprises an inlet orifice which is provided with at least two coolant inlet port groups composed of a plurality of coolant inlet ports such that a distance between adjacent coolant inlet port groups is made to be larger than a distance between adjacent coolant inlet ports in the coolant inlet port group.

14. A core inlet structure for coolant according to claim 1, wherein said vortex control means has a structure in which at least one end of the inlet orifice is supported by a surface of a coolant passage in the fuel support member.

15. A core inlet structure for coolant according to claim 14, wherein the vortex control means comprises a plurality of parallel vertical plates and is disposed inside the coolant passage in the fuel support member at a portion upstream of the inlet orifice.

16. A core inlet structure for coolant according to claim 14, wherein the coolant inlet port of the fuel support member has a lower end which is disposed below a lower end of the reinforcing beam.
